(19) United States
(12) Patent Application Publication
(10) Pub. No.: US 2019/0008716 A1
(43) Pub. Date: Jan. 10, 2019

(54) Physical Therapy Tools and Related Methods

(71) Applicant: Wave Tools, LLC, Lyons, CO (US)

(72) Inventors: Jeff Giddings, Lyons, CO (US); Laura Schmonsees, Lyons, CO (US); Frank Giddings, Fort Collins, CO (US)

(21) Appl. No.: 15/642,083

(22) Filed: Jul. 5, 2017

(51) Int. Cl. A61H 7/00

(52) U.S. Cl. CPC A61H 7/003; A61H 2201/0153; A61H 7/001; A61H 7/007

(57) ABSTRACT

The invention may relate to handheld, tissue manipulation tools (e.g., massage therapy and physical therapy tools) that feature, in particular embodiments, perhaps four or more of the following different components: levered pressure surface (component), massage edge, blade edges, disc edge, pressure knob, finger arc blade edge, stripper, adhesion release blade edge, tendon release blade edge and/or forearm arc blade edge. Alternate articulations include, e.g., a tissue manipulation tool having both edge and edgeless components; and a tool having rounded components and bladed edge components. Various grip surfaces may facilitate comfortable and precisely controlled manipulation of the tool by its user.

### BACKGROUND OF THE INVENTION

Physical therapists often treat patients using techniques that apply pressure to, massage, or otherwise manipulate soft tissue (including muscle and connective tissue) of their patients. Known tissue manipulation techniques involve manual or tool-based application of force to tissue in several ways. Physical therapy tools, known and used for many years, have been used in physical (and massage) therapy practice to, e.g., improve results, facilitate manipulation, and/or better achieve certain therapeutic goals. Known tools are used, e.g., to apply massaging strokes and deep trigger point pressures, and, perhaps with the use of an edge tool, to decrease fibrous adhesion or scarring.

Known physical therapy tools fail into one of two categories: blade edge tools to decrease scarring and fibrous adhesion; and non-edge (edgeless), rounded massaging tools that are used to apply massaging strokes and trigger point pressures (note that some massaging tools may include rounded edges). It is not known to combine both functions into a single tool. Known edge tools also come in sets of several (e.g., 3-8) different tools, with various arcs and facets to help treat different body parts and conditions. Known edge tools also tend to be one dimensional, i.e., flat, such as those stamped out of stainless steel, and they can be difficult to hold on to and control, especially when used with lubricating lotions. Their “flatness” and/or failure to allow for natural intuitive gripping where tool surfaces conform to the interior of a user's curled, gripping hand), may preclude user comfort and tool control during long therapy sessions.

Physical therapists know all too well the impact daily, manual treatment of their patients has on their hands, thumbs, fingers and associated tissue (e.g., muscle, tendon, etc.). Oftentimes physical therapists must shorten their careers, or cut back on the number of patients they care for, due to strain on their hands, fingers and thumbs. Embodiments of the inventive tool technology disclosed herein allow a therapist to apply appropriate pressures to their patient using a tool via ergonomic grips, thereby decreasing pain, strain, and the potential for overuse type injuries in the treating therapist, and possibly even extending a therapist's career. Of course, at the same time, the inventive tool allows for effective treatment of the patient.

There are manually held and manipulatable (by a user such as a therapist) tools currently available to physical (and massage) therapists to help treat patients using contact-based therapeutic techniques to manipulate tissue, but such tools each come with one or more of the following disadvantages: more than one tool required to comprehensively treat a patient; awkward to grasp/use; limited type and range of therapeutic components available in tool form, and available in a single tool; and inability to leverage tool and achieve therapeutic pressure on the treated individual, and reduction in strain on the therapist, as but a few examples. Embodiments of the tool as described herein may alleviate one or more of such disadvantages.

### SUMMARY OF THE INVENTION

Embodiments of the inventive technology relate to an apparatus (a tool) usable by, e.g., a physical therapist, massage therapist or other person (generally, a user) to achieve beneficial therapeutic effect on an individual who may benefit from contact-based therapy to achieve a health-related goal. That individual be a human person, such as a physical therapy patient, massage therapy client, or even non-patient (or non-client), or even a non-human such as a dog or horse, etc. More particularly, certain embodiments relate to a handheld tool (i.e., a tool that is or can be held and operated with a single hand) with a plurality of different therapeutically effective components. Such components, whether an edge, surface, and/or a generally shaped or molded mass, etc., can be used, particularly by a skilled or trained practitioner, to effect a variety of myofascial and/or other treatments (generally, tissue manipulation).

Embodiments of the inventive tool may achieve any of several objectives as indicated anywhere in this application. Certain generalized goals that particular embodiments of the inventive technology help to achieve may include (but certainly are not limited to): incorporation into a tool a plurality of therapeutic components that each has special therapeutic application/function; incorporation into a tool a plurality of therapeutic components in addition to grip surfaces that can each be used to enable proficient control of one or more of such components; a tool that allows for levered pressurization as part of a therapeutic treatment; a tool that provides one or more of the following: stripper (i.e., stripper component), disc edge, levered pressure surface (e.g., a lever disc) and finger arc blade edge; a tool that incorporates two dissimilar therapeutic components—a blade edge component(s), and a rounded component(s) (e.g., a rounded edge component, or rounded edgeless surfaces, at least part of which has a functional (skin contacting) surface that, in cross section, is rounded, where rounded could be, e.g., part of a sphere's cross-sectional surface or merely a curved surface with different radii of curvature); and a tool with both edge and edgeless components. Note that, at times herein, a component (e.g., the forearm arc blade edge component), may be referred to using the component's distinguishing feature (e.g., the forearm arc blade edge), without the term component. Of course, objectives/goals, general and specific, other than those indicated above may be as indicated elsewhere in this specification.

Note also that where a tool is described as a physical therapy tool, then it has potential application and use in at least physical therapy; such characterization does not preclude its use in other tissue manipulation applications (including but not limited to massage and massage therapy). If a tool can be used in physical therapy, it is a physical therapy tool. So even if such “PT” tool is used as a massage tool, strictly in a massage practice or application, or marketed strictly to massage therapists or for massage, it is still considered a physical therapy tool if that tool could be used to achieve physical therapy treatment. Nonetheless, the inventive technology disclosed and claimed herein may at times be referred to broadly as a handheld tissue manipulation tool; such tool includes but is not limited to a tool usable in massage and physical therapy (i.e., a massage therapy tool and a physical therapy tool). Tools finding predominant use in physical therapy may include blade edges.

As mentioned, particular embodiments of the tool may be unique in that they incorporate both rounded components (e.g., one or more of rounded massage edge, pressure knob, levered pressure surface such as a lever disc) and blade edges (e.g., adhesion release blade edge, tendon release blade edge, arced blade edge (e.g., finger arc blade edge and/or forearm arc blade edge), disc edge) in one tool, thereby allowing for the use of very different treatment procedures and techniques with that single tool (note that blade edges other than the finger and forearm arc may also show a slight arc; it would not nearly be to the degree seen with the forearm and finger arc blade edges). Known rounded components, with rounded features 9 (edge or edgeless) would find application in physical therapy to treat the patient's muscle belly with stroking, massaging, kneading, ironing, and/or deep trigger point pressures, to increase blood flow, decrease pain, and decrease muscle trigger point activity; known blade edges are used in physical therapy to treat areas of fibrosis or scarring within the tendon, at the tendon attachment into the bone, or in the mid-portion of a muscle if scarring and fibrosis are present. The blade edge is also used to decrease fascial scarring and fascial adhesion. The blade edge acts to microscopically tear or fray the abnormal fibrotic and scarred tissue—micro-trauma that leads to a healing response in the treated tissue by the body's natural immune and inflammatory systems. All preceding examples are types of tissue manipulation. Note that tissue is a broad term, and includes muscle and connective tissue (e.g., tendons, ligaments).

Embodiments of the tool (i.e., at least one of the many embodiments) may resolve at least some of the deficiencies with known physical therapy tools by combining edge and edgeless technologies into a single unit, resulting in one tool that is able to treat all parts of a patient's body, is three dimensional, and designed to be ergonomically held and easy, and comfortable, to manipulate.

Embodiments of the tool allow the treating therapist or other person (generally, a user) to feel areas of scarring and fibrosis within the affected tissue that otherwise cannot be palpated or sensed by the hand or fingers. More particularly, a blade edge gliding across normal tendon or muscle tissue will do so without resistance from the tissue and will feel smooth to the user. If, however, the blade edge is run over scarred and fibrotic tissue it will catch and feel bumpy or lumpy to the therapist/user, and perhaps to the patient. Such can generally not be sensed by the user without the use of a tool with a blade edge.

Embodiments of the tool may have a unique levered pressure surface (e.g., a lever disc) that can be used in certain designs, e.g., with an enclosure or a reverse enclosure grip, to increase the amount of pressure applied by the physical therapist through simple mechanical advantage. This is useful for treating larger muscle groups such as the gluteal and hip rotator muscles that generally require a large amount of manual force to apply therapeutic pressures. Relatedly, certain embodiments of the tool (whether that tool has a lever disc or not) have a unique disc edge that can be used to treat difficult to access tendons and muscles such as, for example, the rotator cuff tendons below the acromion process, the plantar fascia insertion on the calcaneous, and the subscapularis muscle on the underside of the scapula. The disc edge is preferably (but not necessarily) blade edged.

Embodiments of the tool may incorporate a unique stripping component (the stripper) that is moved, during use, parallel to (a term that includes co-linear with, and side-by-side parallel to) the direction of the muscle and tendon fibers to break down adhesions between the fibers or bands of muscle; during stripper use the plane of the tool (e.g., the bisecting plane) will typically be substantially parallel to the direction of the muscle and tendon fibers being treated. Certain blade, and massaging (rounded), edges on the tool are also typically moved in a direction that is parallel to the direction of the muscle and tendon fibers to be treated (a muscle or fiber or tendon may have a muscle or tendon longitudinal axis, which can be said to be the muscle's or tendon's direction). During motion of bladed components that lie within the bisecting plane of the tool, the tool can still be held such that its bisecting plane is oriented substantially perpendicularly to the direction of the muscle or tendon fibers, perhaps rearwardly or forwardly angled, but the best treatment using some components, e.g., the forearm arc blade edge, the finger arc blade edge, the tendon release blade edge and/or the adhesion release blade edge, may be achieved when the tool's bisecting plane is angled back (rearwardly) from the direction of motion (e.g., in a manner similar to a snow shovel); indeed all blade edges, during use, may effect best response when they are angled back (e.g., 40°-50°) from skin as they are moved forward (i.e., more like a snow shovel than a rake). However, such is not the only orientation in which blade edges (or the massage edge) can be moved; one of ordinary skill in the art would be able to move components in an appropriate orientation and direction to achieve a desired treatment or effect.

Edgeless surfaces may also be moved in any of many directions relative to any direction the treated muscle/tendon/tissue may define—circular direction, repeated stroking in one or more directions, parallel, perpendicular, angled to such direction, etc., or perhaps not moved significantly along the skin surface at all, as where a pressure alone is cyclically applied with some component of force, e.g., in towards bone. Substantially stationary application may include those uses where some smaller degree of motion, e.g., kneading and/or repeated minor circular arc, ironing and/or digging or pushing motions, are used during pressure application.

Certain embodiments of the tool may incorporate four (or more) different types of blade edge components (e.g., forearm arc blade edge, tendon release blade edge, adhesion release blade edge, and finger arc blade edge) and at least three different types of rounded components, e.g., rounded massage edge and rounded, edgeless surfaces (e.g., levered pressure surface such as lever disc, and pressure knob) that can be used to treat most all therapeutically treatable tendons, tissues and muscles in the body, making it possible for the therapist to use only one single, discrete tool instead of several in order to treat virtually any medical issue that is treatable using physical therapy techniques. Note that embodiments may also incorporate a stripper, which has a portion thereof (a leading edge) that may have a rounded shape, and a different portion thereof (a trailing part) that is edged (bladed typically, but also, instead, possibly round edged). Where the stripper includes a blade edge, then it is a blade component.

### BRIEF DESCRIPTION OF THE DRAWINGS

Note that in the figure descriptions that follow immediately below, and in descriptions appearing elsewhere in this disclosure, where indication is to an embodiment, such does not preclude the referenced feature as appearing in other embodiments.

FIG. 1 shows a view of an embodiment of the inventive tool from the left (note that orienting terms like left, right top, bottom, front and rear are merely nominal and arbitrary, and assigned, and used consistently, to facilitate description; indeed, at times, for example, what is referred to herein, as the top front of a tool may be at the bottom rear with respect to a user (see, e.g., the reverse enclosure grip)).

FIG. 2 shows a perspective view of an embodiment of the inventive tool from the above front left.

FIG. 3 shows a perspective view of an embodiment of the inventive tool from the above rear right.

FIG. 4 shows a view of an embodiment of the inventive tool from the right.

FIG. 5 shows a view of an embodiment of the inventive tool from the front.

FIG. 6 shows a view of an embodiment of the inventive tool from the rear.

FIG. 7 shows a view of an embodiment of the inventive tool from above.

FIG. 8 shows a view of an embodiment of the inventive tool from below.

FIG. 9 shows a view of an embodiment of the inventive tool from the right; showing surface angle changes and lines where differently oriented surfaces meet.

FIG. 10 shows a view of an embodiment of the inventive tool from the left, showing possible dimensions (ratios therebetween are also merely exemplary).

FIG. 11 shows a view of an embodiment of the inventive tool from above, showing possible dimensions (ratios therebetween are also merely exemplary).

FIG. 12 shows a user's exemplary “enclosure grip” on an embodiment of the tool, from left of the user (as with all images showing a grip or grip surface, the user is right handed; left handed use would present as images that are mirror symmetric to those shown). Of course, grips and grip surfaces as shown in associated figures may vary somewhat from what is shown.

FIG. 13 shows a user's exemplary “reverse enclosure grip” on an embodiment of the tool, from left of the user.

FIG. 14 shows a user's exemplary “pinch grip” on an embodiment of the tool, from left of the user.

FIG. 15 shows a user's exemplary “large palm grip” on an embodiment of the tool, from left of the user.

FIG. 16 shows a user's exemplary “small palm grip” on an embodiment of the tool, from left of the user.

FIG. 17 shows a user's exemplary “large pistol grip” on an embodiment of the tool, from left of the user.

FIG. 18 shows a user's exemplary “small pistol grip” on an embodiment of the tool, from left of the user.

FIG. 19A shows an exemplary enclosure grip surface 31 (on an embodiment of the tool), from the user's right (exemplary right-handed user); the cross-hatched surface(s) is the grip surface.

FIG. 19B shows an exemplary enclosure grip surface 31 (on an embodiment of the tool), from the user's left.

FIG. 19C shows an exemplary enclosure grip surface 31 (on an embodiment of the tool), from above the tool.

FIG. 19D shows an exemplary enclosure grip surface 31 (on an embodiment of the tool), from below the tool.

FIG. 20A shows an exemplary reverse enclosure grip surface 32 (on an embodiment of the tool), from the user's right.

FIG. 20B shows an exemplary reverse enclosure grip surface 32 (on an embodiment of the tool), from the user's left

FIG. 20C shows an exemplary reverse enclosure grip surface 32 (on an embodiment of the tool), from above the tool.

FIG. 20D shows an exemplary reverse enclosure grip surface 32 (on an embodiment of the tool), from below the tool.

FIG. 21A shows an exemplary pinch grip surface 33 (on an embodiment of the tool), from the user's right.

FIG. 21B shows an exemplary pinch grip surface 33 (on an embodiment of the tool), from the user's left

FIG. 21C shows an exemplary pinch grip surface 33 (on an embodiment of the tool), from above the tool.

FIG. 22A shows an exemplary large palm grip surface 34 (on an embodiment of the tool), from the user's right.

FIG. 22B shows an exemplary large palm grip surface 34 (on an embodiment of the tool), from the user's left

FIG. 22C shows an exemplary large palm grip surface 34 (on an embodiment of the tool), from above the tool.

FIG. 23A shows an exemplary small palm grip surface 35 (on an embodiment of the tool), from the user's right.

FIG. 23B shows an exemplary small palm grip surface 35 (on an embodiment of the tool), from the user's left

FIG. 23C shows an exemplary small palm grip surface 35 (on an embodiment of the tool), from above the tool.

FIG. 24A shows an exemplary large pistol grip surface 36 (on an embodiment of the tool), from the user's right.

FIG. 24B shows an exemplary large pistol grip surface 36 (on an embodiment of the tool), from the user's left

FIG. 24C shows an exemplary large pistol grip surface 36 (on an embodiment of the tool), from below the tool.

FIG. 25A shows an exemplary small pistol grip surface 37 (on an embodiment of the tool), from the user's right.

FIG. 25B shows an exemplary small pistol grip surface 37 (on an embodiment of the tool), from the user's left

FIG. 25C shows an exemplary small pistol grip surface 37 (on an embodiment of the tool), from below the tool.

FIG. 26A shows a perspective view of an embodiment of the inventive tool from the lower left rear; it shows the leading part of the stripper, and finger arc blade edge particularly well. Note the pressure knob at the upper right, and the levered pressure surface (here, a lever disc) and disc edge at the upper left of the figure.

FIG. 26B shows a side view of a stripper as may appear in an embodiment of the inventive technology.

FIG. 27 shows the stripper (including at least some of its trailing part), and a portion of the adhesion release blade edge, of an embodiment of the inventive tool via perspective view from below, left and slightly rearward.

FIG. 28 shows the stripper, the adhesion release blade edge, and at least a portion of the finger arc blade edge of an embodiment of the inventive tool via perspective view from below, right and slightly rearward.

FIG. 29 shows a close up of the stripper (note that less than all of the trailing part is shown) from below and rearward of an embodiment of the inventive tool.

FIG. 30 shows a close up of the disc edge and the front portion of a lever disc) as may appear in an embodiment of the inventive tool, from the front of that tool.

FIG. 31 shows a side view of an embodiment of the inventive tool having two disc edges, two lever discs, two pressure knobs, two massage edges, and two forearm arc blade edges.

FIG. 32 shows a side view of an embodiment of the inventive tool having two pressure knobs (one with one radius of curvature, the other with another), a finger arc blade edge, an adhesion release blade edge, a stripper, and a (rounded) massage edge.

FIG. 33 shows, in exemplary fashion, how the tendon release blade edge, as appearing on an embodiment of the inventive tool, may be used.

### DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application. Any parts, components, etc., shown in the figures are merely exemplary.

Embodiments of the inventive technology relate to an ergonomic, handheld, manually manipulatable apparatus (a handheld tool 1) usable by, e.g., a physical therapist or other person (generally, a user) to achieve beneficial therapeutic effect on an individual, human or otherwise. More particularly, certain embodiments relate to a handheld, manually manipulable tool 1 with a plurality of different, therapeutically functional components. Such components, whether an edge, surface, and/or mass, etc. (all of which may be shaped, molded or otherwise), can be used, particularly by a skilled or trained practitioner, to effect a variety of myofascial or other treatments. The tool can also be used, to at least some benefit, by other than trained physical or massage therapists (i.e., self-administration/treatment is also possible).

The tissue manipulation tool 1, such as physical therapy tool, in certain embodiments, may include two or more of the following therapeutic components 2: a disc edge 23; a levered pressure surface 22 (e.g., a lever disc); a massage edge 24; a pressure knob 29; a finger arc blade edge 27; a stripper 28; an adhesion release blade edge 21; a tendon release blade edge 25; and a forearm arc blade edge 26. Each of such components may have a shape and/or position relative to the tool that facilitates a particular therapeutic effect. Such effect may include but is not limited to one or more of the following: scar tissue massage; adhesion (scar tissue) breakup/release; trigger point release; fibrous tissue release; massage; soft tissue mobilization; increase in blood flow to a particular area of the body; breakdown of crossed muscular fibers; promotion of tissue regeneration; stimulation of fibroblasts; lengthening of shortened muscle fibers; myofascia pressurization; myofascia pinning and stretching; improvement of neuromuscular pathways; realignment of muscle fibers; treatment of particular parts of the body (e.g., of finger tendons/pulleys) and/or relaxation of tense/knotted fibers. Each therapeutic component, whether edge component 6, blade edge component 8, rounded component 10, rounded edge component 12, edgeless component 15 and/or rounded, edgeless component 14 (note that a single component may be more than one of the prior component types) may be particularly suited, via design, shape, size, position relative to hand of user, and/or position on the tool, to have a specific functionality, some of which may be as follows (note that the following component features/descriptions may be found for such component in particular, but not necessarily all component embodiments):

Levered Pressure Surface 22—apply pressure to a body part; treat trigger points; in those designs that also have a pressure knob 29, the levered pressure surface will typically have a “flatter”, less aggressive, but typically still rounded, skin contact surface as compared with any pressure knob 29 (e.g., the levered pressure surface 22 may be more of a small portion of, e.g., a pool ball's surface, and have a larger average radius of curvature (e.g., approx. 1.3″) than any pressure knob 29 (which may be more like a portion of a ping pong ball or large marble)); typically, applies more distributed, less “focused” pressure than, e.g., a pressure knob 29, although it may perhaps be used in levered manner to increase pressure, perhaps to apply greater pressure than any pressure knob 29; lever disc 55 is merely one example of a levered pressure surface.

Disc Edge 23—pinning and stretching to small regions of myofascia; pressurization adjacent to a bone or bony protuberance; scraping; levering (application of a levered force/pressure) on or to myofascial bands, such as scapular border, calcaneus, carpal tunnel subacromial arch; generally, applying “focused” pressure to a body part; when disc edge 23 is found on tool, it often presents as an outer edge to a levered disc.

(Rounded) Massage Edge (Component) 24—massage, blood flow improvement, trigger point release; myofascial pin and stretch along larger areas of tissue/muscle, e.g., quads, forearms, calves; exemplary average radius of curvature is 0.4″ (within the exemplary range of 0.3′-0.5″).

Pressure Knob 29—pressurize and release trigger points, with a more aggressive, “less flat” surface (smaller average radius of curvature) as compared with the levered pressure surface 22 (i.e., more of portion of, e.g., a ping pong ball's surface (although the knob's surface, like that of the levered pressure surface, need not be perfectly spherical segment in shape)); an exemplary average radius of curvature of the pressure knob 29's therapeutic (e.g., skin contacting) surface may be, e.g., approximately 0.4″ (although certainly other radii are possible). It may, in certain embodiments, be similar to size as the end of a large thumb; may also be referred to as trigger point knob; may be used to mimic pressures applied directly during tool-free treatment via a therapist's thumb; it may be particularly effective in treating muscle trigger points.

Finger Arc Blade Edge 27—for use on finger pulley and achilles tendon, thumb web space, small areas; treatment of finger and pulley overuse, fibrosis and traumatic injury (note that with the finger arc blade edge 27, as with the forearm arc bladed edge, the component name does not preclude use of that component on other body parts).

Stripper 28—strips fascia apart; during use, a leading part thereof, perhaps substantially at the end of a projection of the tool, may be forcibly (but still, preferably comfortably) pressed into and between muscle fibers, and dragged parallel to those fibers, then a trailing part, such as an edge (bladed or rounded, for example) part thereof may help to spread fibers apart; achieves adhesion release parallel to tissue, e.g., forearm, multifidi; useful in treating shin splints.

Adhesion Release Blade Edge 21—release adhesions and micro-tearing of tissue to promote a healing and regenerative response; for use perpendicular to tissue (where component's (longitudinal) axis is perpendicular to, e.g., muscle, while tool may be moved parallel to such muscle); may serve as a primary adhesion and fibrosis release edge; may be referred to as a large (or larger) blade edge.

Tendon Release Blade Edge 25—breaks apart scar tissue; treatment of tendinosis; may be particularly effective in achieving tendon release; may also be used to treat smaller areas, often around a bony protuberance where the tendon attaches; may be used along joints such as knees and elbows; may be used following initial treatment with the adhesion release blade edge 21 along the entire muscle/tendon complex (the tendon release blade edge 25 could then be used for “fine tuning” at the tendon attachment); may be referred to as a small (or smaller) blade edge.

Forearm Arc Blade Edge 26—breaks apart scar tissue; particularly suited for, e.g., forearms; for use perpendicular to tissue (where component's longitudinal (long) axis (which the component has even though the edge is curved) is perpendicular to, e.g., muscle, although tool may be moved parallel to such muscle); this component and others, e.g., the finger arc blade edge 27, may be ergonomic in that they have radii of curvature(s) that are intended to substantially match those of target (intended) tissue/region (e.g., finger or forearm); may also be used on, e.g., ankle or wrist; has a larger radius of curvature than finger arc blade edge 27; may be referred to as wide (or wider) arc blade edge.

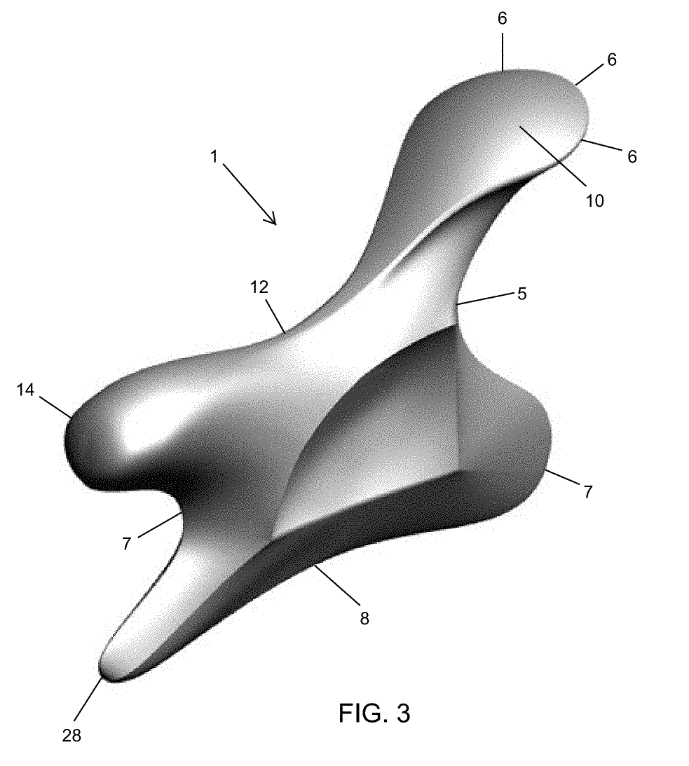

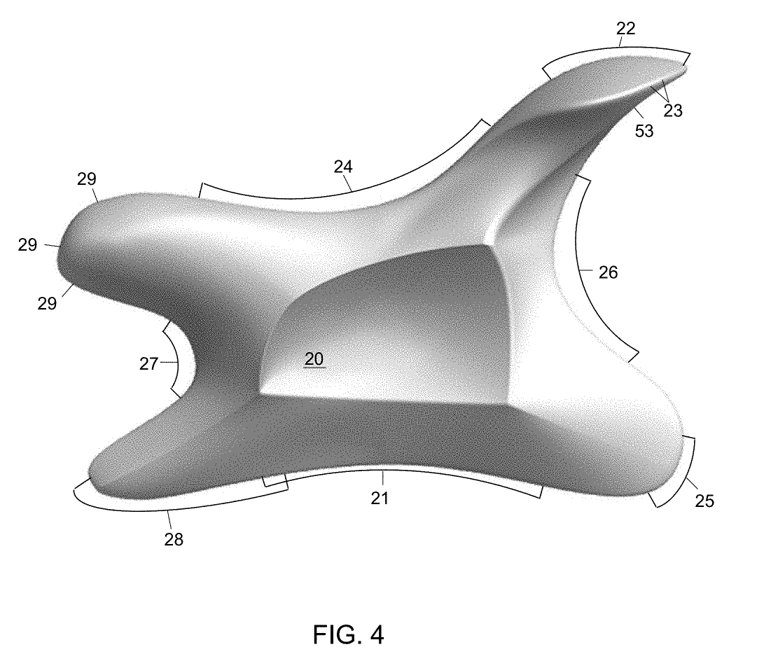

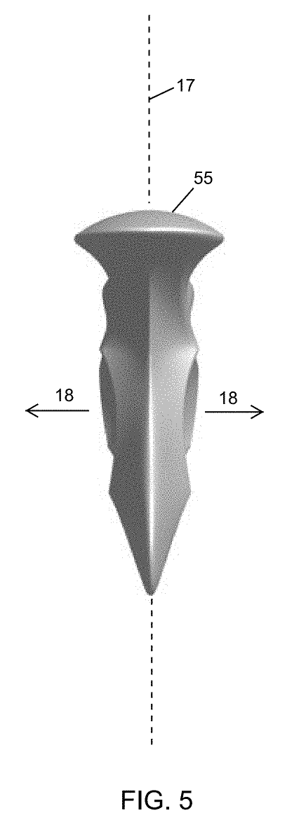

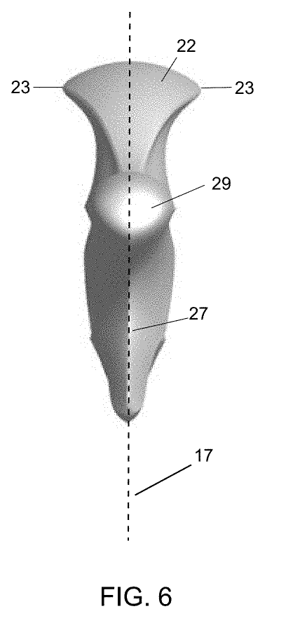

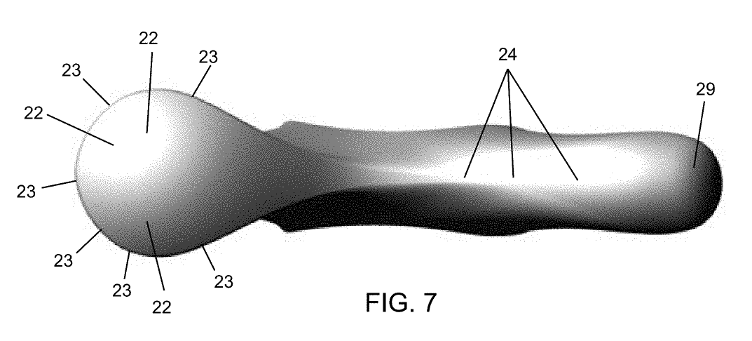

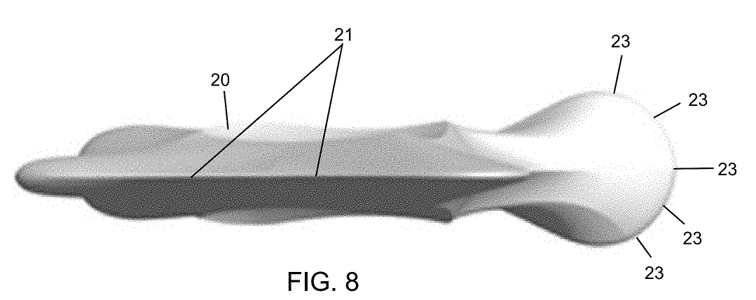

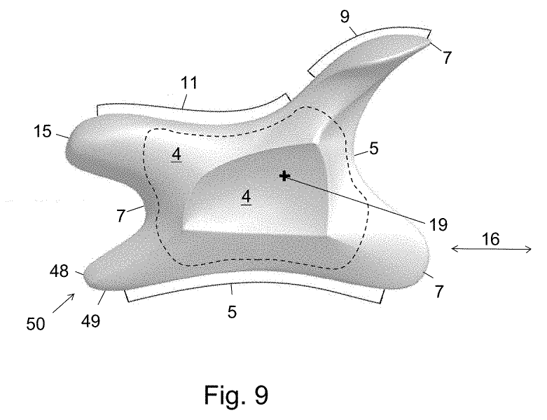

With particular relevance to the figures, note that it is not the case that all presentation in the figures of a certain component or feature are indicated with every numeral that applies to that component or feature. Also, even on the same figure, even though the same numeral (e.g., edge 5, rounded feature 9, edge component 6, rounded component 10) may apply to more than one component or feature, it is not the case that every such component or feature is indicated with that number (indeed, such numerals are used in only exemplary fashion (see, e.g., FIGS. 3 and 9)).

Note that while each component may indeed be suited for a particular application or achieve a particular effect, each component may still be used to achieve other effect(s) or have additional application. For example, the tendon release blade edge 25, while particularly suited for scar tissue breakdown and tendon release, may also be used to effect stripping of fascia apart. And of course, achievement of one therapeutic effect (e.g., tissue massage) may concomitantly achieve another (e.g., increased blood flow). Note also that, even where a certain component is disclosed herein explicitly as having a blade edge, this disclosure is intended to also disclose other embodiments of the technology that use an amended, different version of that component, e.g., where instead of a blade edge that edge is rounded.

Blade edges (of blade edge components 8) are typically “sharper” than, e.g., the rounded massage edge 24 (a type of rounded edge component 12) but for safety/functionality reasons, they may simply be sharp enough, and no sharper, to achieve intended scraping/scar tissue break up/tissue separation, or other intended effect, under application of therapeutic force/pressures. Without limiting the cross-sectional profile shape of any of the edges 5 (blade edge 7 or rounded edge 11) of edge components 6 (components that have at least a portion that is an edge), “sharpness” of such components may mimic or be within those ranges exhibited by any known blade or rounded edges used in existing tools. An exemplary range of radius of curvature for a blade edge 7 (at edge tip) may be 1/32″- 3/32″ (inclusive), while an exemplary range of radius of curvature for a rounded edge 11 may be 0.3″-0.5″ (inclusive), without limitation. But generally, an edge with a radius of curvature (at edge tip) of greater than 3/32″ may be said to be a rounded edge; a rounded edge with a radius of curvature that is greater than 0.5″ may be referred to as a rounded surface. Note that where radius of curvature for a component changes for that component, an average radius may be considered (and in such cases, the term radius of curvature is an average radius of curvature). In certain embodiments, blade edges 7 may present with an angle (of sides leading to the very end (tip) of the edge) of from 33° to 38°, inclusive although other angles, such as, e.g., 45° are also possible). These angles and radii are merely exemplary. Possibly the most relevant consideration for blade edges may be, as mentioned, that they not be so sharp as to possibly cut or damage skin or tissue during application of therapeutic force/pressure, but are “sharp” enough to achieve the desired treatment (perhaps in addition to a sensing by the user (and possibly the patient also) of irregularity in tissue) by the user. Damaging skin or tissue may be of particular concern when a blade edge(s) is moved in a direction that is parallel to the longitudinal axis defined by that blade edge (e.g., the trailing part of the stripper 28, which may, in certain embodiments, be part of the adhesion release blade edge 21).

While a preferred embodiment of the invention technology may indeed include nine different therapeutic components that each is specially and/or intentionally shaped to achieve a certain therapeutic effect and/or be particularly suitable for use on a specific body part, certain other embodiments may simply include only two or more different types of components. For example, one embodiment may be a tool with one adhesion release blade edge 21 and one or more of eight other components (i.e., one or more of: a levered pressure surface 22 (e.g., a lever disc 55); a disc edge 23; a massage edge; a pressure knob 29; a finger arc blade edge 27; a stripper 28; a tendon release blade edge 25; and a forearm arc blade edge 26). Of course, some of such embodiments may be simply any of the tools shown in the figures with one or more of the edge components 6 in the perimetrical space between projections eliminated.

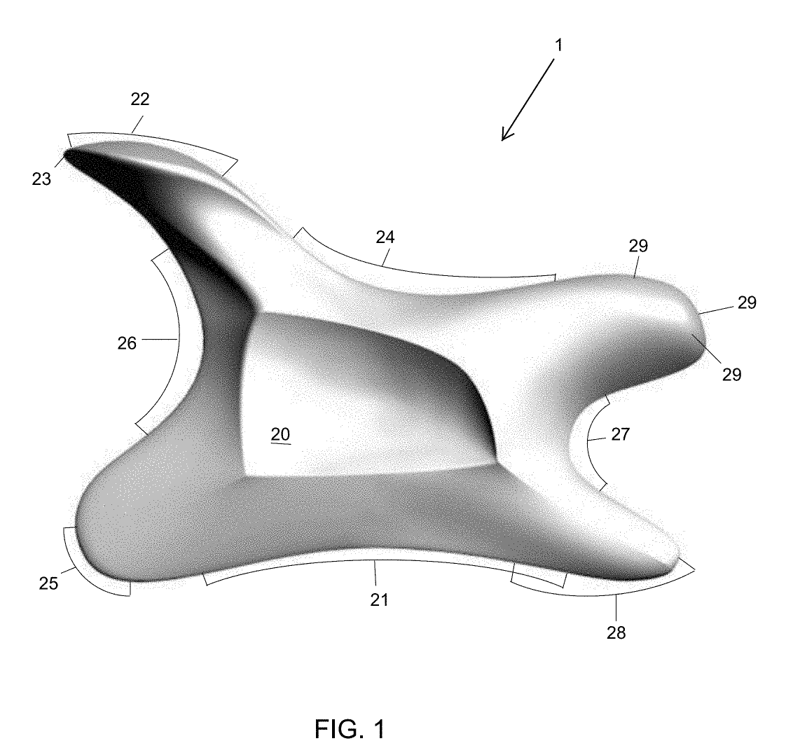

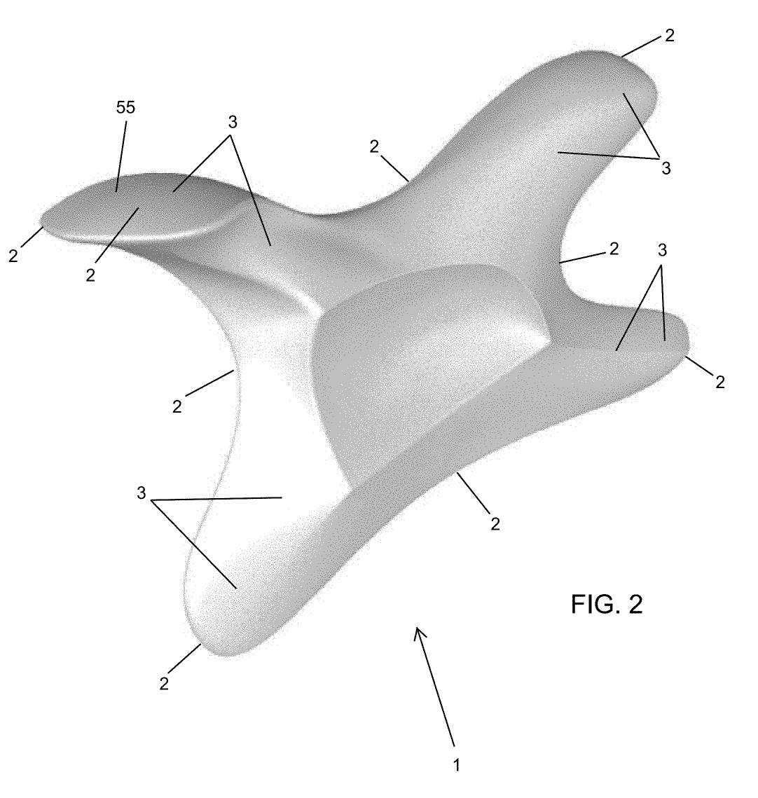

Note that, regardless of the number of therapeutic components, the tool may have a central tool portion 4 (demarcated, in exemplary fashion, by the dashed line in FIG. 9), and each of the components may be established radially outward from that central tool portion, whether at the end of a projection (e.g., levered pressure surface 22) or not (e.g., the adhesion release blade edge 21). A therapeutic component may be viewed as the structure that, during therapeutic use, contacts the individual to be treated (i.e., the functional surface, whether blade, edge, pressure surface, surface having depth (in a right-left direction), or other), in addition to immediately supporting structure therefor. Such supporting structure may be the material established from that functional surface up to approx. ¼″ towards the tool's mass centroid, which, in FIG. 9, is the area centroid 19, but on the bisecting plane. Any lever disc 55 is the disc, plus the material established up to ¼″ in from that disc surface in towards the mass centroid. A central portion 4 of the tool may be viewed as a mass that includes the mass centroid (which, in many designs, when the tool is viewed from left or right, will align with the area centroid), and that extends outward towards, but does not include, the therapeutic components, or any projections from that central tool portion 4. Typically, the central tool portion 4 includes any digit indentation 20 that may exist; it (the central tool portion) atypically may, but certainly need not, have a hole through it (typically it may be solid (without a hole), as shown in FIG. 9). Note that in certain figures, components are indicated with brackets that indicate the profile of their functional surface (see, e.g., FIG. 1); in other figures, lines (without brackets) point more generally to portions of that surface, including portions that are off of that profile (e.g., on the pressure knob 29 or the levered pressure surface 22).

A component may be said to be established substantially at the end of a projection (e.g., a radial projection 3), or form part of a projection. Note that the term radial does not imply circle shape at all; any sites, locations or parts of a shape or mass (whether symmetric about an axis or not), whether on the surface of that shape or mass or not, that are not at or on the central portion (e.g., the component free area that includes the area centroid 19 when viewed from the side) of that shape or mass, may be viewed as radially outward from that central portion.

Another articulation of the inventive technology, in embodiments, may be a handheld tool that incorporates both: (a) one or more rounded components 10 (e.g., massage edge (a rounded edge, instead of a blade edge), pressure knob 29, levered pressure surface 22 such as a lever disc 55); and (b) one or more blade edge components 8 (i.e., one or more of an adhesion release blade edge 21, disc edge 23 (typically blade edged), tendon release blade edge 25, forearm arc blade edge 26, and finger arc blade edge 27). Yet another alternate articulation of the invention, in embodiments, may be a handheld tool that incorporates both: (a) one or more edgeless (i.e., non-edge) component 15 (e.g., one or more of the levered pressure surface 22 or the pressure knob 29); and (b) one or more edge component 6 (i.e., one or more of a rounded massage edge 24, stripper 28, disc edge 23, adhesion release blade edge 21, tendon release blade edge 25, forearm arc blade edge 26, and finger arc blade edge 27).

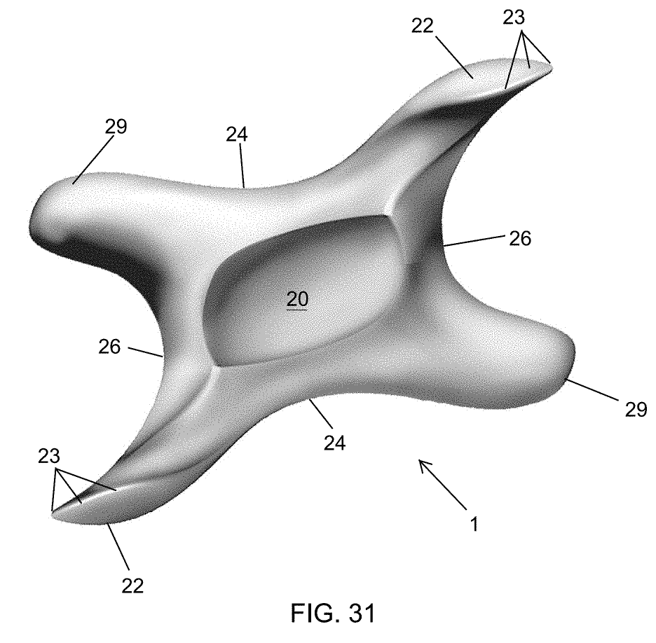

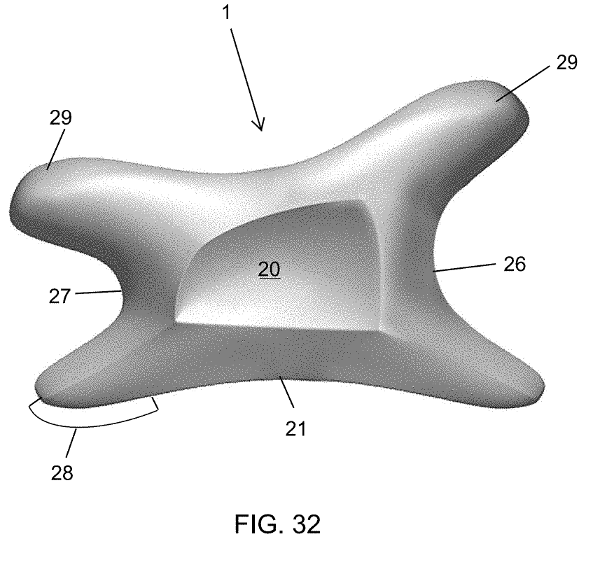

Exemplary tools having fewer than nine (or eight) different component types may be shown in, e.g., FIGS. 31 and 32. FIG. 31 shows a tool with two disc edges 23, two levered pressure surfaces 22 (shown as lever discs 55), two pressure knobs 29, two massage edges, and two forearm arc blade edges 26. FIG. 32 shows a tool with two pressure knobs 29 (one with one radius of curvature, the other with another), a finger arc blade edge 27, an adhesion release blade edge 21, a stripper 28, and a (rounded) massage edge. Tools with more than one of the same component (type), in different locations are also within the ambit of the inventive technology; they may offer advantages such as facilitating tool use by eliminating the need to change grips when switching from use of one particular component to another. Of course, these are merely two of many different possible examples of “limited” component tools. Other inventive tools may, e.g., have only one component type (e.g., a stripper 28, finger arc blade edge 27, or disc edge 23), two different component types, or three/four/five/six/seven/eight different component types. As with any tool shown or described herein, these tools can be further modified (via component elimination, duplication, or addition) to create different toots with even fewer (in number and/or type) components (or more components). Indeed, this application should be understood as describing tools that comprise any, one or more of any of the therapeutic components and/or features indicated herein, including all permutations and combinations thereof; one of ordinary skill in the art could mix components, components with features, and features (based on this disclosure, perhaps also in view of known technology), as desired. How to design such tool would be understood by one of ordinary skill in the art from this disclosure, and within that ordinary artisan's ken, particularly in light of the knowledge generally available at the time of filing.

As mentioned, embodiments of the inventive technology relate to the incorporation of therapeutic components as indicated herein in a tool, i.e., one single tool. Such tool can have one part (such that no assembly or connection of two or more parts is necessary to create the entire tool as intended), but this is not a required feature. Accordingly, the inventive tool can be a single piece or part (e.g., where no assembly of different parts is required to form a single tool), or it can be assembled parts, as where different parts can be connected in some manner to form a single tool. The latter type may be seen, e.g., where different therapeutic components can be selectively snap connected, magnetically connected, or twist locked, etc., to, e.g., a central tool portion.

Note that certain components of the tool are inventive by themselves, and a tool with only one or more of such component (of course other components may be incorporated into the tool) is an embodiment of the inventive technology. For example, the stripper 28 is, by itself, inventive. Similarly, the disc edge 23 is, by itself, inventive. The finger arc blade edge 27 is also, by itself, inventive. The levered pressure surface 22 (and a type thereof, the lever disc 55), is also, by itself, inventive. The forearm arc blade edge 26 may also, by itself, be inventive. Accordingly, a handheld (hand grippable) tool that comprises any one of such components is within the ambit of the inventive technology. Accordingly, the following are examples of the inventive tool, in embodiments:
a tool with a stripper 28 alone; a tool with a stripper 28 and any additional component(s) (e.g., any one or more of the other eight components indicated above);
a tool with a disc edge 23 alone; a tool with a disc edge 23 and any additional component(s) (e.g., any one or more of the other eight components indicated above);
a tool with a finger arc blade edge 27 alone; a tool with a finger arc blade edge 27 and any additional component(s) (e.g., any one or more of the other eight components indicated above);
a tool with a forearm arc blade edge 26 alone; a tool with a forearm arc blade edge 26 and any additional component(s) (e.g., any one or more of the other eight components indicated above); and
a tool with a levered pressure surface 22 alone; a tool with a levered pressure surface and any additional component(s) (e.g., any one or more of the other eight components indicated above).
   Of course, as with any of the many embodiments of the tool, such tools may include grip surfaces, described in more detail below.

The stripper 28 (stripping component) is an inventive therapeutic component by itself. When used it may help to release adhesion or fascial restriction. It may be used by sliding it in a direction that is parallel to that defined by the muscle or tendon fibers, and with an appropriate force against such muscle or tendon fibers. Its skin contacting portion 38 (during use of the component) may have a leading part 39 and a trailing part 40: the leading part (which may all be of substantially the same shape/orientation) may be that part that substantially first contacts skin of a patient as the stripper 28 is moved; the trailing part (which may all be of substantially the same shape/orientation that is different from that of the leading part) is the part of the stripper 28 that follows, during movement of the stripper 28, the leading part and helps to separate or further separate tissue that was pressurized by the leading part. The trailing part may be, but is not necessarily, significantly sharper than the leading part. Note that, depending on the precise use (e.g., the tool's angle of attack relative to skin), the very “front” of the leading part of the stripper 28 may contact skin before or at the same time as other portions of that leading part. Note that, as used herein with respect to the stripper 28 or other components, a component is said to have a “skin contacting” surface or be moved “against skin” even where there is a layer of fabric (e.g., clothing) between the component and the actual skin surface of the person treated.

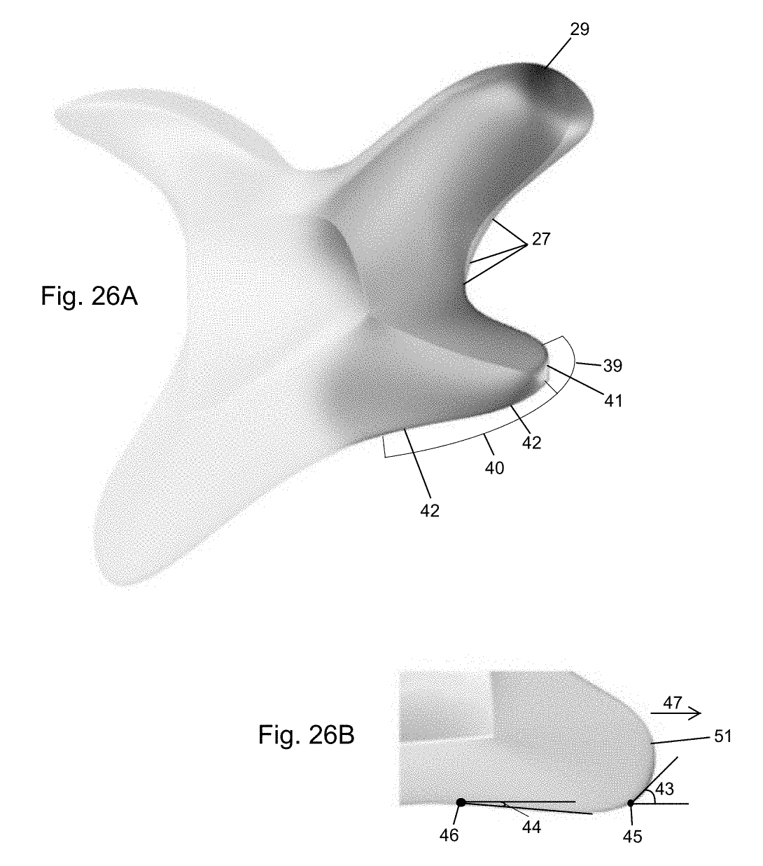

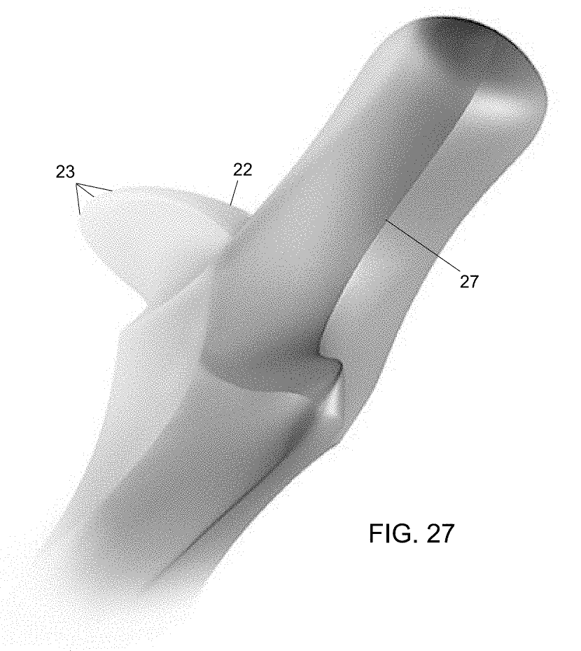

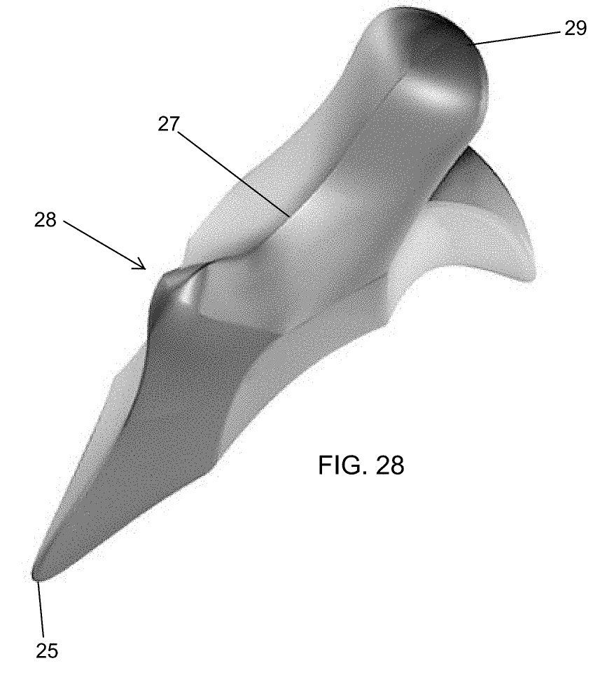

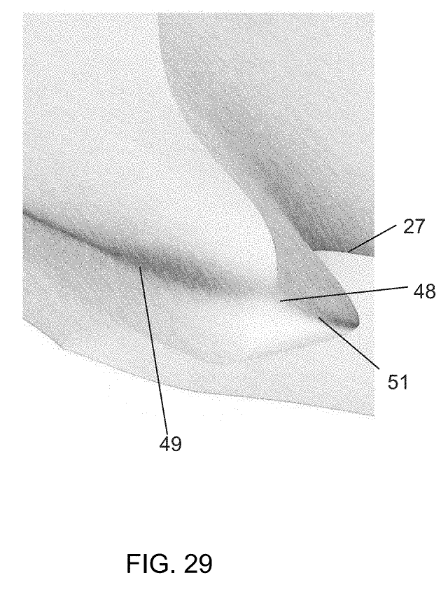

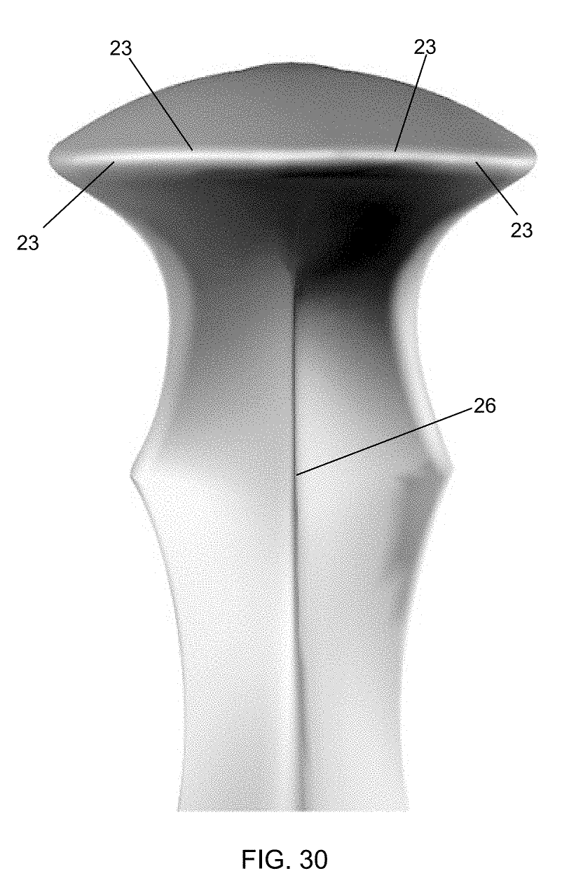

The leading part of the stripper 28 component may be of rounded shape in normal cross-section (i.e., any of the cross-sections that includes a normal projection from that surface that makes up the component's profile); it may (but need not) be established at the end of a projection (even a small projection) of a tool that the stripper 28 is a part of, and may have a blunt nose 51 shape. At least part of the trailing part may be an edge, whether blade edged or rounded edged, although a blade edge may be most effective in treating/spreading apart tissue or tendon. Where part of the edge part of the stripper 28 includes at least a portion that is bladed, the stripper 28 may be referred to as a blade edge component 8; where the edge includes more than just a relatively small transitional portion (at a rear portion of leading part or front portion of trailing part) that is rounded, it may be referred to as a rounded edge component. In particular embodiments, the leading part may define a first average forward angle 43 with respect to a (horizontal) component operational movement direction 47, and the trailing part may define a second average forward angle 44 with respect to said component operational movement direction. Vertices 45, 46 of such angles, respectively, may each be at a rearward-most portion of the leading part 41 and the trailing part 42, respectively. The first average forward angle is typically positive, acute and greater than the second average forward angle (by, e.g., at least 20°, at least 45°, at least 60°, or at least 70°). The second average forward angle may be negative (as shown in FIG. 26B), but need not be negative. Note that the stripper 28 component, in particular embodiments, in profile from left or right side, may exhibit a bow 48 (ignoring the part of the analogous boat's bow that is above the water surface) and keel 49 shape 50 of a boat. Indeed, as a boat cuts through water, the stripper 28 component may also be slid against skin and in a direction that is parallel to that defined by tissue to be treated, to treat that tissue.

Note that there need not be a pronounced demarcation between the leading and trailing parts of the stripper 28 component. However, in certain embodiments, the leading part may be viewed as ending, and the trailing part as beginning, substantially midway along the part of the profile of the stripper 28 that exhibits a change in angle (from the angle defined by the steeper, overhanging bow portion of the stripper 28 to the angle defined by the much flatter keel portion of the tool). Note that in certain embodiments, there may be a bow portion that substantially aligns with the leading part, and the keel portion that substantially aligns with the trailing part. It is also of note that in particular embodiments, the trailing part (or at least a portion thereof) may also form at least part of another component of the tool (e.g., the adhesion release blade edge 21); nonetheless, even though they may share a portion of the tool, the two components (stripper 28 and adhesion release blade edge 21) are considered different components (this characterization applies to other components as well). The location on the tool (e.g., on the adhesion release blade edge 21) that, during operation of the stripper 28 via typical movement of the tool and typical pressures, comes out of contact with skin may define the end of the stripper 28. Note that the term substantially, as used herein (with regard to any description), includes deviations up to and including 10% on each side of exact conformance.

The orientation of the leading part (e.g., the angle in a bisecting plane), may help to comfortably introduce what typically is the sharper trailing part (that follows it as the stripper 28 is used) into a position between muscle or tissue; that sharper edge (of the trailing part) may help to separate that muscle or tissue. The sharper edge may, in cross-section, have a V shape (even a rounded edge is said to have a V shape). On the tool of FIG. 1, e.g., one preferred way of using the stripper 28 component is via the small palm grip, moving the tool towards the tool user against skin of an individual.

The tool may include a levered pressure surface component 22. That surface may be rounded (including smoothly curved, whether as part of a sphere, part of a smoothly curved)), and convex. It may be part of a rounded structure (e.g., including but not limited to a sphere) at the end of a projection. It may be part of a disc (including a partial disc or wafer) at the end of a projection. Regardless of the exact shape, it may be leveraged during use (e.g., via use of reverse enclosure grip and an enclosure grip), although it may also be used (perhaps without leverage) in other grips (pinch grip), as indicated. Leverage may be achieved via application of levered force/pressure through pressurized contact (with skin) of the convex surface of the levered pressure surface 22 via, e.g., a reverse enclosure grip and downward, forward motion of hand, perhaps even with some clockwise (from left of user) rotation about an axis normal to a tool bisecting plane 17). In that grip, a part of the user's hand (e.g., the interior part), including the heel and/or palm of the hand, may be used to apply downward force to the tool that is transferred through the levered pressure surface 22 to the body part to be treated; the establishment of that tool at the end of a projection (which may, but need not, have a radial length from tool centroid that is greater than that of other projections) may play an important role in achieving levered pressurization. It may also help to achieve an articulated orientation that may facilitate and enhance use and application. A reverse enclosure grip may situate the levered pressure surface 22 below the hand of, and towards (proximal) the user, while an enclosure grip may situate such surface in front of the user's hand and away from the user, enabling recruitment of strong forearm/hand muscles (by the user) to apply pressure directly against one part of the tool (e.g., the adhesion release blade edge 21 for both grips) in a rotational direction (e.g., clockwise for the reverse enclosure grip; counter-clockwise for enclosure grip). Fingers help to maintain the grip, and to apply the desired pressurized force. In the enclosure grip, the web space area of the hand may apply much (even most) of the force that pressurizes the levered pressure surface during treatment with that component.

As mentioned, the levered pressure surface 22 may present substantially as a disc (a term that which includes a partial (e.g., ½, ⅓) disc)) established substantially at the end of a projection. Such may present an opportunity for efficient design, where a border of that disc is blade edged, thereby providing a disc edge 23. Accordingly, certain embodiments of the tool may include a disc edge 23 and/or lever disc 55 (a tool may have neither, one without the other, or both), possibly at the end of the same projection.

In embodiments, the lever disc 55 may be a portion of a curved surface that has a substantial center that is within a bisecting plane 17 of the tool; it typically presents as a convex surface, substantially as a spherical segment (or spherical cap) (it need not be a segment of a perfect sphere) with a height that is, e.g., less than 25% the average radius of curvature (as merely one example), but typically not non-negligible. It may, in certain embodiments, present at the end of a “craned neck” projection, and substantially as at least a front portion of a soup spoon turned upside down, so as to present convexly. Like the levered pressure surface 22 generally, a lever disc 55 may present with a radius/radii of curvature that point(s) substantially downwards when the tool is situated such that the lever disc 55 is substantially at the tool's upper portion (as shown in, e.g., FIG. 1).

Note that the term disc (of lever disc 55 or disc edge 23) merely implies a shape (e.g., from above it) that resembles at least part of a disc (with any thickness, and even where presenting, when viewed from above, with a partial closed curve (e.g., partial oval, partial circle, partial closed curve, arc of a curve, semi-circle, semi-oval, etc.)) Part of the disc (or levered pressure surface 22 generally) may be occupied/not exist/not be visible where the disc connects with supporting structure (e.g., a projection) that the disc sits atop. Like the levered pressure surface that the lever disc 55 is a type of, the lever disc 55 may be leveraged during use (e.g., via use of enclosure or reverse enclosure grip), although it may also be used without leverage in other grips (pinch grip, enclosure grip), as indicated.

In certain embodiments, the tool may include a disc edge 23; in some of such embodiments, the disc edge 23 may partially surround a lever disc 55. The disc edge 23 that may be an edge at the end of a projection, and lying substantially within a plane that is perpendicular to a bisecting plane (the plane that splits the tool in right and left portions (e.g., mirror image halves)); the plane of the disc edge 23 may be substantially horizontal (including, without limitation, inclined (e.g., up to 30°) upwards from perfectly horizontal) when lower parts of the tool are set on a horizontal surface, but this is not required. Like the lever disc 55, the disc edge 23 may present at the end of a projection; such projection may, but need not, have a “craned neck” appearance. The disc edge 23 may include bladed portions that are substantially parallel to the tool's bisecting plane, but outside of that plane; such portions, particularly when at the end of a projection, may present in articulated manner, allowing the user to access difficult to reach tissue. Further, the disc edge 23 is typically curved such that, when viewed from above (in certain embodiments), it exhibits a radius of curvature (e.g., pointing towards the rest of the tool (e.g., rearwards, when the disc edge 23 is at the front of the tool); such radius of curvature may be, as but one example, approx. ¾″). The disc edge 23 may have a curved shape resembling a semi-circle (in certain embodiments, such may be apparent from above the tool), or more generally arc of a curve, with a bisecting line that lies in the tools bisecting plane. Also, it may also, when viewed from the front, exhibit a curve with a radius of curvature pointing towards the rest of the tool (e.g., downwards, when the disc edge 23 is at the top of the tool); and/or it may be curved such that it does not lie perfectly within a plane. It is of note that even where its edge (typically a blade edge) is slightly curved such that it does not lie perfectly within a plane (e.g., up to 10% deviation therefrom), it may still be said to lie substantially within that plane.

The disc edge 23 may often be used in any of the ways in which a blade edge can generally be used, although its orientation (i.e., presentation of a blade that is not within a bisecting plane of the tool) and/or location at the end of a projection can, for certain treatment on certain body parts (e.g., applying pressure under bone or tissue), allow it to be used perhaps more comfortably and/or effectively by a therapist. Indeed, in certain embodiments, the disc edge 23 may lie substantially within a plane that is perpendicular to a tool bisecting plane; such disc edge 23 plane may, but need not, be substantially horizontal and or present as a substantially semicircle or circular (or oval or curved) arc.

Relatedly, it is of note that a component is considered edgeless where an edge is not critical to the component's achievement of an intended therapeutic effect; even where an edge is in the area or immediately adjacent a component, or even appears to give a certain shape to a component, if such edge does not play a role in the function of that component, that component may be referred to as edgeless. Accordingly, a lever disc 55, which may in certain embodiments be on the end of the same projection as the disc edge 23, and thus have an edge (e.g., disc edge 23) directly next to it, may still be referred to as an edgeless component in such embodiments. The lever disc 55, generally may have its disc shape (a term that includes partial disc shape), but instead of as shown in particular figures, could be presented out of the immediate vicinity of an edge component. The levered pressure surface 22 also is typically a rounded (surface) component and even an edgeless component.

In certain embodiments, the finger arc blade edge 27 may generally have a shape (viewed from the tool's left or right side) with a smallest radius of curvature at a portion (e.g., a central portion of that blade edge) and increasing radii of curvature on either side of (e.g., above or below) that smallest radius portion as a distance along the edge and away from that portion increases; the edge can become flat (i.e., a radius of curvature of zero) at some point on either or both sides. The finger arc blade edge 27 has a shape that allows for effective treatment of, e.g., a finger component (e.g., a finger pulley), and thus typically has a central curve that, when viewed from the right or left side, has a shape that allows at least a middle portion of that central curve to fully contact the intended finger part. To allow for this, the shape of the central curve may have a smallest radius of curvature that is not so small as to preclude such contact (e.g., in one embodiment, such radius of curvature may be approx. ⅓″-½″), and the blade may exhibit increasing radii of curvature on either side (along tool perimeter) of that central portion. The tool perimeter is the outer profile of the tool when viewed from right or left side; it may lie within a bisecting plane of the tool. Other than particular radius of curvature dimension, the forearm arc blade edge 26 (component) may follow analogous design principles, but for the forearm.

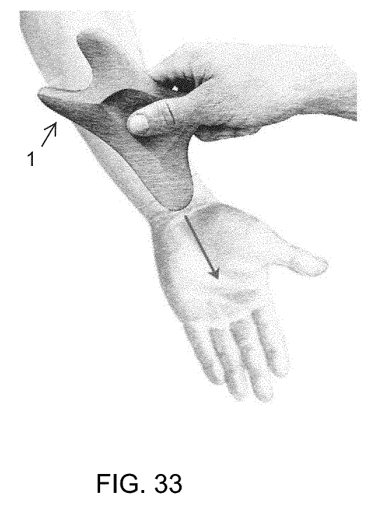

The tendon release blade edge 25 may have a longitudinal axis that is within a bisecting plane of the tool. During use thereof, this component (and a bisecting plane of the tool) may be oriented at an angle (e.g., approx. 45°) to skin that is “behind it” (on trailing side of tool during use) and pushed forward like a straight snow shovel. It may be moved, in typical application, parallel to, e.g., tendon or other tissue; see FIG. 33 for exemplary use.

In particular embodiments of the inventive technology, when “moving” from edges (other than, perhaps, any disc edge 23) in towards the tool area centroid 19 (when viewed from the left or right), the surface of the tool may be said to rise from such edges until the outer boundary of the thumb and/or finger(s) indentation (digit indentation 20) is reached (in embodiments with such indentation), at which point the surface of the tool falls towards the indented central regions of the digit indentation. Such “rise” and “fall” is out of and into the page, respectively, in diagrams showing left or right views of the tool. Varying width (in a direction that is perpendicular to the bisecting axis) of the tool may play an important role in making it ergonomic for the user. Note that an ergonomic tool means that it affords one or more ergonomic grip via ergonomic grip surfaces; it may also feature ergonomically designed therapeutic components (e.g., the forearm arc blade edge 26), which have a shape that may facilitate treatment of a certain body part (e.g., forearm).

Embodiments of the inventive technology may use ergonomic angles and shapes for therapeutic components; such angles and shapes may conform to body tissues/parts of a patient or other individual to be treated. In such manner, certain components (e.g., the finger arc blade edge 27 and forearm arc blade edge 26) may be particularly suited for use on a particular part of the body (e.g., finger pulleys and achilles tendon). More generally, as mentioned, while rounded components (e.g., rounded massage edge 24, or rounded, edgeless surface components 14 (with rounded, edgeless surfaces 13) such as the levered pressure surface 22 and pressure knob 29) typically have shapes that make such components particularly effective in massage, and to increase blood flow and release trigger points, blade edges (forearm arc, finger, disc edge 23, small and adhesion release blade edge 21) typically have shapes that make them particularly effective in breaking down scar tissue.

Ergonomic design may not be limited to the therapeutic components of the tool alone; indeed, ergonomics may also be used to provide the tool, in any of its various embodiments, with one or more comfortable, intuitive, hand grippable surfaces (grip surfaces), thereby providing an ergonomic, handheld tissue manipulation tool with comfortable grip that, perhaps more importantly, allows for at least adequate control (“control” includes user ability to apply sufficient force pressure, directionally as desired) of the tool by a user. Use of each therapeutic component may be facilitated by use of at least one particular grip of the tool by a user; each grip may facilitate the use of one or more of the tool's therapeutic components. In certain embodiments, a (possibly central) digit indentation 20 may facilitate gripping of the tool in a certain way(s), enhance tool use, help provide firm grasping of the tool, and/or help a user to quickly re-orient the tool within his/her hand; such indentation may form a part of one more grip surfaces of the tool.

Note that while a grip is something afforded by the tool, and not a part of the tool, three dimensional surfaces that allow a particular grip (and that are in contact with a user's hand during that grip)—i.e., specific grip surfaces (e.g., a palm grip surface)—are part of the tool. A grip surface is the portion of the outer surface of the tool that a user's hand contacts during use of a certain (hand) grip. Accordingly, certain parts of the tool, or, more particularly, sections/portions of the three-dimensional outer surface of the tool, may indeed allow for the grip, and even make it ergonomic and comfortable. As such, the tool may be said to be intentionally designed and configured to allow for certain hand grips. Note that certain embodiments of the tool are intentionally designed so that all grip surfaces are ergonomic (in that they allow for an ergonomic grip by a tool user). However, in certain embodiments, a grip may merely be how best to grip, or adequately and intuitively grip, the tool in order to adequately control it during use, and be less ergonomic than other grips. Note also that where a single certain grip involves hand contact with surfaces of the tool that are not contiguous, such surfaces are still termed a grip surface.

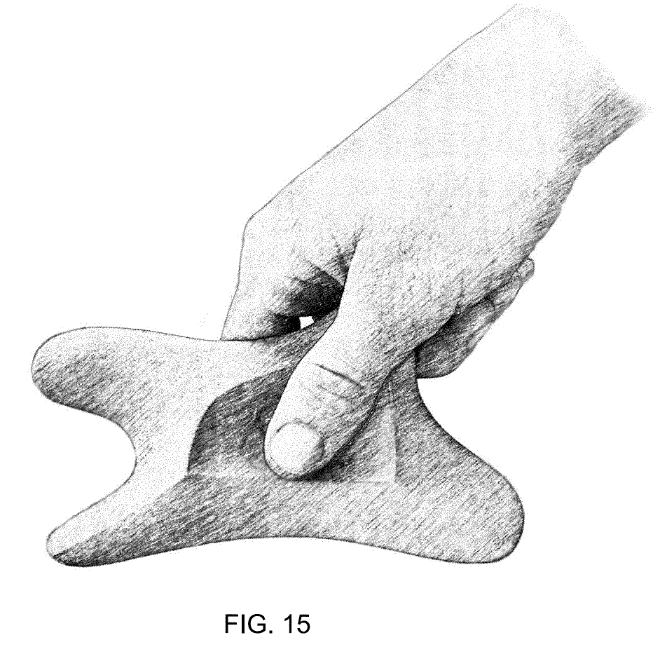

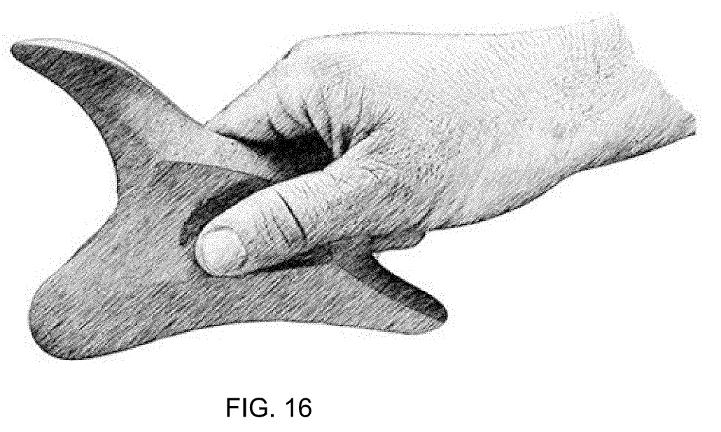

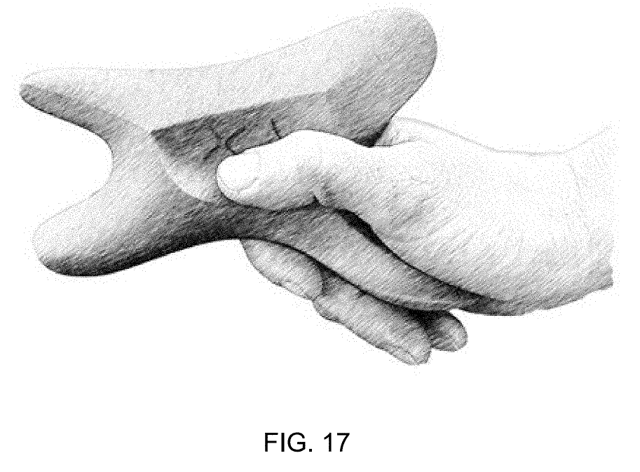

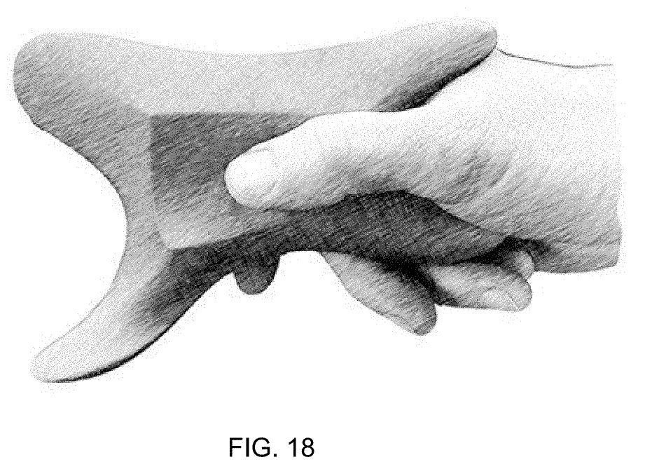

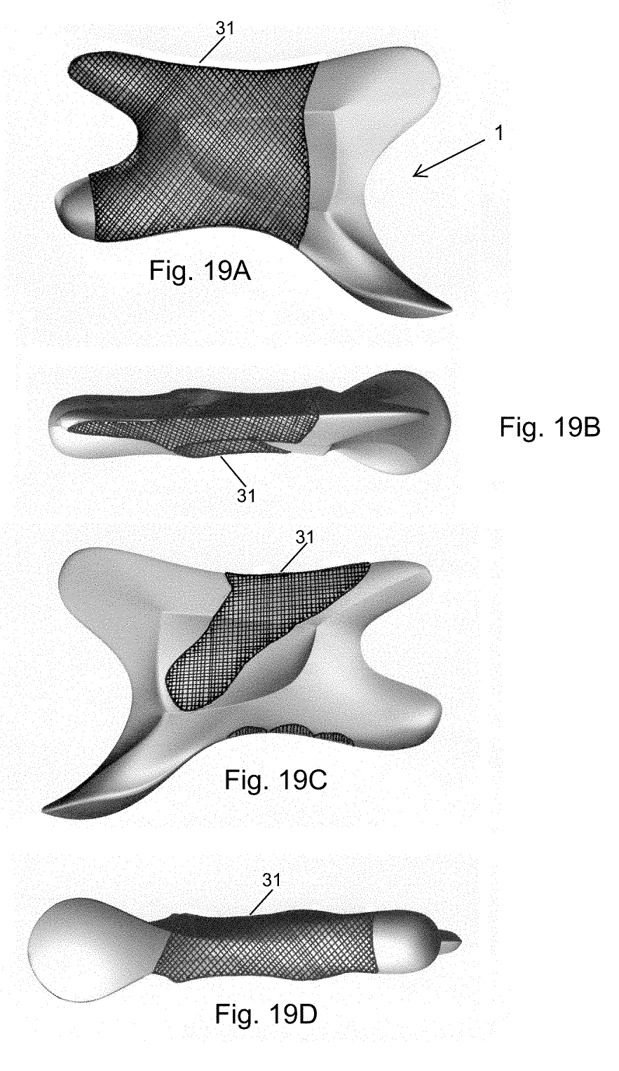

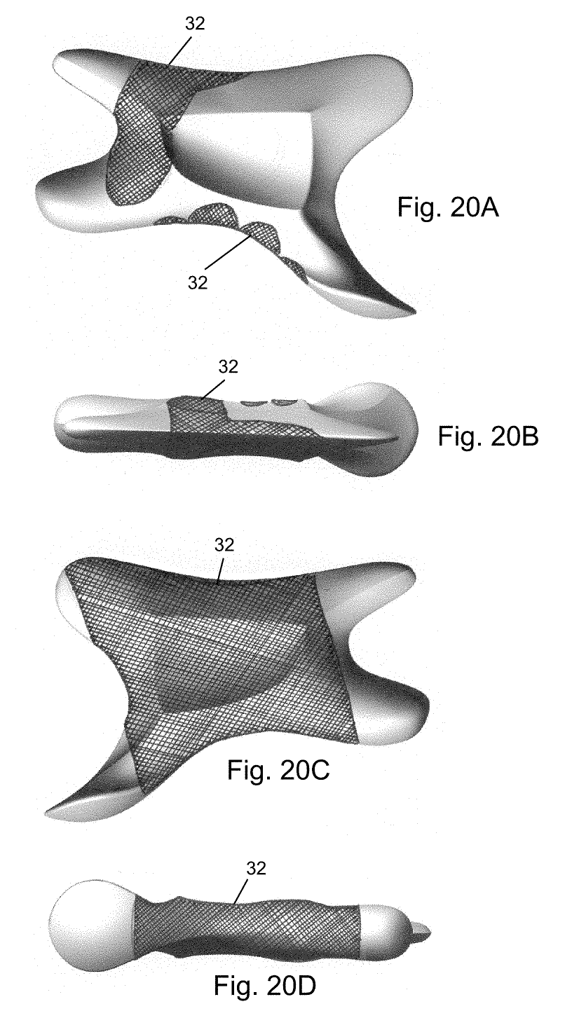

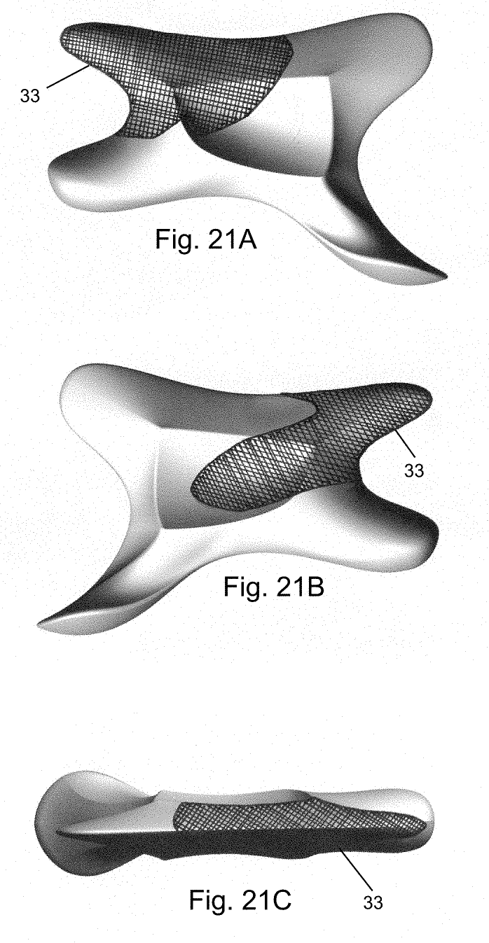

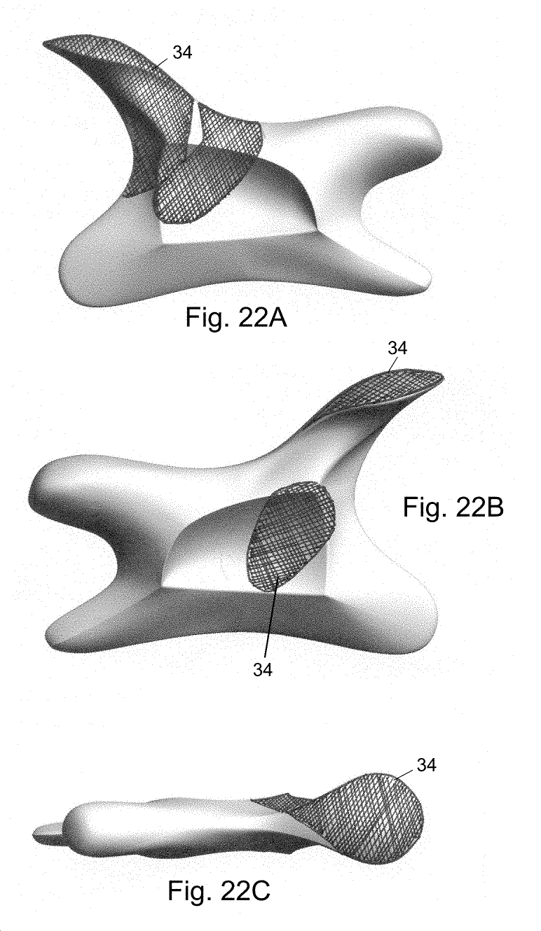

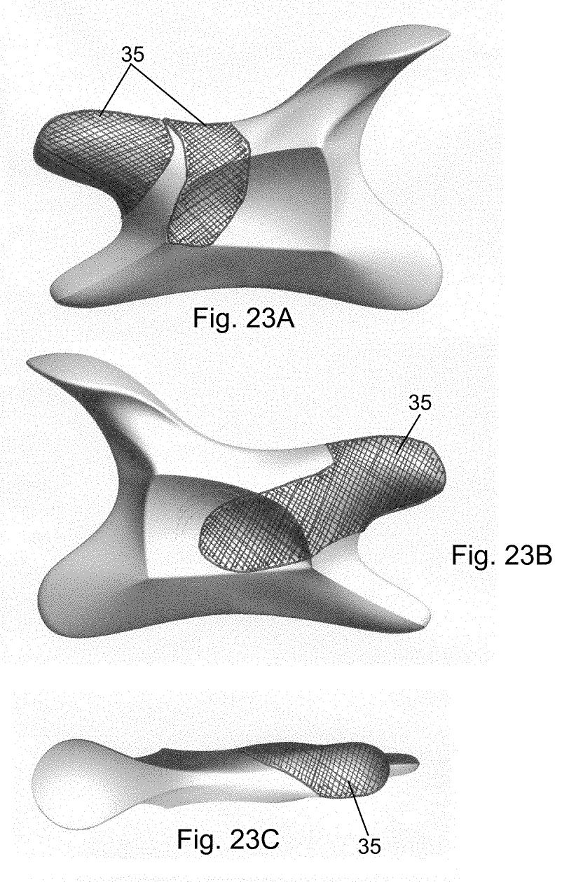

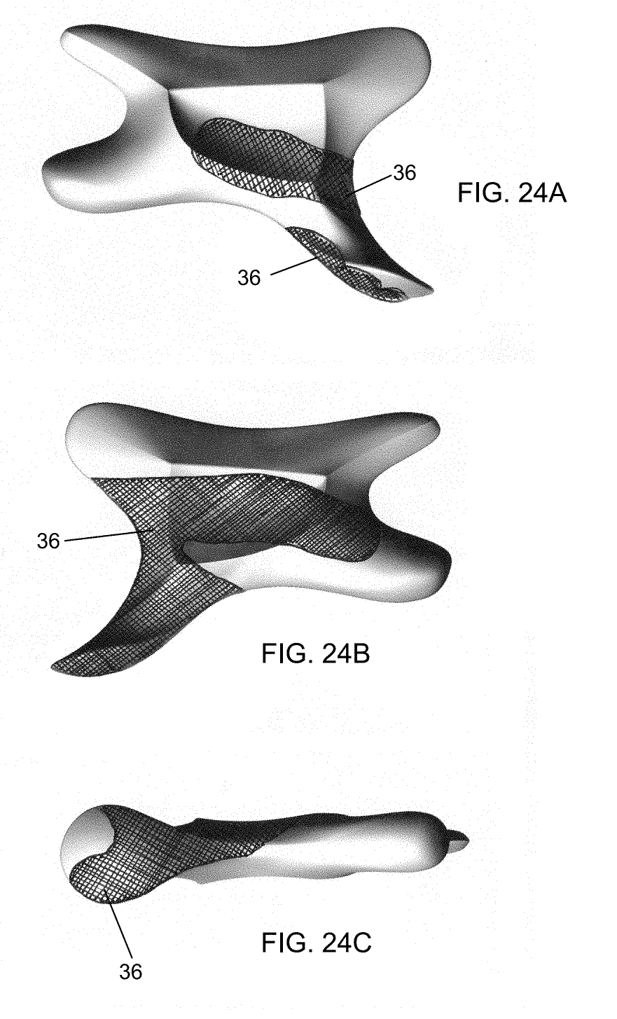

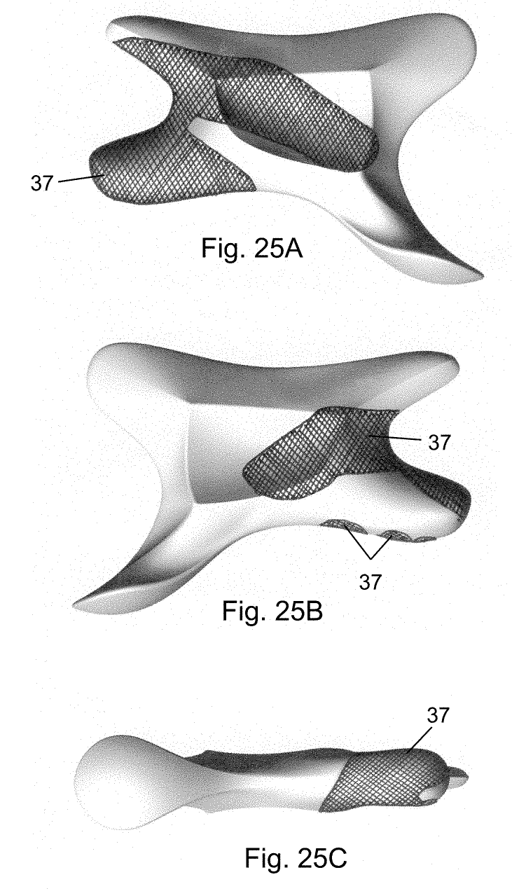

Each grip surface allows for adequate control of a certain therapeutic component(s) of the tool. One way such control and/or ergonomics may be facilitated is through use of a changing thickness (thickness in a right-left direction) of the tool; such variation in thickness in three dimensional grip surfaces may allow the tool user's hand to at least partially surround the tool or portion thereof and, more particularly, allow the user to employ the natural curl of his/her finger(s), palm and/or thumb via their contact with and conformation to the tool surface, resulting, in certain embodiments, in comfortable, often substantially even pressure on the user's contacting palm, finger and/or thumb surface. Such changing thickness, perhaps resulting in a shape that conforms to the interior surfaces of the curled fingers of a user may instead, or additionally, allow for tool contact with substantially all of, or at least a majority portion of, the interior surface of the curled fingers, palm, and thumb. The changing thickness may result in certain bulbous or width enhanced tool portions (e.g., therapeutic components) that enhance tool control because such portions, in certain grips, are in the palm of the hand (while a component applies therapeutic pressure), with curled fingers wrapped around that portion (see, e.g., in certain tools of FIGS. 15, 17, the large palm grip and the large pistol grip, where the levered pressure surface 22 is within the curled palm; and FIGS. 16, 18, showing the small palm grip and the small pistol grip, where the pressure knob 29 is within the curled palm). Accordingly, the large palm grip and the large pistol grip may also be referred to as “levered pressure surface centered” palm and pistol grips, respectively; the small palm grip and the small pistol grip may also be referred to as “pressure knob 29 centered” palm and pistol grips. Certain handheld tools, such as thin/flat/substantially two-dimensional tools, are certainly grippable, but the grip surfaces thereof would likely not be ergonomic nor offer adequate control of the tool, particularly at higher tool-on-patient pressures, due to, e.g., pressure differentials on contacting surfaces (e.g., high pressure at flat tool edges) and/or significant areas of the interior surface of gripping fingers, thumb and/or palm that are not in contact with the tool.

More particularly, an aspect of ergonomic design may be coordination of shape and location (on the tool) of various component(s) (e.g., finger arc blade edge 27, pressure knob 29 and stripper 28) and non-component part(s) (e.g., the central portion, such as central structure) of the tool to establish a three-dimensional surface that admits of a certain hand grip(s), and allows for adequate control of a component(s) of the tool, and perhaps does so comfortably and/or intuitively. Such may be accomplished by shaping of a tool to substantially mimic at least part of the various spatial volumes defined by, and within, the palm and inner surface of the fingers and thumb of a hand in various grip positions.

While any shape that is of similar size to the inventive tool can indeed be gripped by a hand (typically in more than one way), grip surfaces are those that allow for adequate control of a certain tool component(s), often doing so in a comfortable way, and are intuitive (in the sense that they can be found easily, remembered easily, and make intuitive sense to the user, due at least in part to their comfort). A specific grip surface may typically be the result of an intentional design, such as thoughtful establishment/positioning on the tool of certain therapeutic component(s) in relation to other parts of the tool (including a central tool structure, digit indentation, other grip surfaces and/or other therapeutic components).

For example, in certain embodiments, a “large pistol grip” may be afforded, at least in part, by a “large pistol grip surface,” which may result from the relative establishment/positioning on the tool of a forearm arc blade edge 26 between two components that radially project (substantially) (e.g., a levered pressure surface/disc edge 23 and tendon release blade edge 25) from the area centroid 19 (in right or left view, e.g., the centroid of the area of the shape shown in FIG. 1) of the tool. Such configuration may help to create a 3D surface section that intuitively, and comfortably, accepts the web space (between the thumb and index finger) of a user's hand, and allows the disc edge 23 and underside of lever disc 55 to rest in the palm (or heel, the proximal part of the palm) of the user's hand, thereby providing at least adequate control of certain tool component(s). The large pistol grip surface of the tool may also include a digit indentation 20 surface. Similarly, the relative establishment/positioning on the tool of a finger arc blade edge 27 between radially projecting components (pressure knob 29 and stripper 28) readily admits a user's thumb web space and may form at least part of a 3D section (a “small pistol grip surface”) that allows a user to grasp the tool via a comfortable “small pistol grip” (as with the large pistol grip surface, the small pistol grip surface may include a digit indentation 20 surface).

Another advantage of certain embodiments of the tool is that, symmetric designs of the tool may allow for identical, but mirror-imaged, grips for both right and left-handed tool users. Accordingly, the tool may include a small pistol grip surface, for example, for both the user's right and left hands, although the figures only show a small pistol grip surface for the right hand. Note that while figures may show grip surfaces for only the right hand, in mirror image symmetric tool designs, there will also be grip surfaces for the left hand; such surfaces would simply be the mirror image of the surfaces shown in the figures for the right hand.

The following are grips, one or more of which may be used on particular embodiments of the tool: pinch grip; large pistol grip; small pistol grip; large palm grip; small palm grip; enclosure grip; and reverse enclosure grip. Each grip has a corresponding grip surface (31-37). Grips may facilitate use of particular components of the tool as follows:

| | Component Whose Use is | |
|---|---|---|
| Grip | Facilitated By Grip | Comments Regarding Grip |
| Large | Pressure knob 29, Finger | Thumb in indentation (finger |
| Pistol | arc blade edge 27 | in second indentation on |
| Grip | | other side of tool); disc edge |
| | | 23/underside of lever disc 55 |
| | | (type of levered pressure |
| | | surface 22) against palm; |
| | | pressure knob 29 down; may |
| | | be particularly ergonomic |
| Small | Disc edge 23, Forearm | Thumb in indentation |
| Pistol | arc blade edge 26, | (midsection of finger in |
| Grip | Tendon release blade | second indentation); pressure |
| | edge 25 | knob 29 in palm; levered |
| | | pressure surface 22 down; |
| | | may be particularly |
| | | ergonomic |
| Large | Adhesion release blade | Thumb in indentation (finger |
| Palm | edge 21, Tendon release | in second indentation); |
| Grip | blade edge 25, Stripper | adhesion release blade edge |
| | 28 | 21 is away from palm; |
| | | levered pressure surface 22 in |
| | | palm; pressure knob 29 up |
| | | and forward (away from |
| | | user); may be particularly |
| | | ergonomic |
| Small | Adhesion release blade | Thumb in indentation |
| Palm | edge 21, Stripper 28 | (finger(s) in second |
| Grip | | indentation); adhesion release |
| | | blade edge 21 is away from |
| | | palm; pressure knob 29 in |
| | | palm; levered pressure |
| | | surface 22 up and forward; |
| | | may be particularly |
| | | ergonomic |
| Pinch | Rounded massage edge | Thumb in indentation (fingers |
| Grip | 24; Finger arc blade | in second indentation); |
| | edge 27; Forearm arc | stripper 28 in palm; levered |
| | blade edge 26; Levered | pressure surface 22 down |
| | Pressure Disc (as shown, | (and forward) |
| | Lever disc 55); Disc edge | |
| | 23 | |
| Enclosure | Levered Pressure Surface | Hand substantially wrapped |
| Grip | 22; Disc edge 23; Finger | around midsection of tool; |
| | arc blade edge 27; Pressure | thumb in indentation; |
| | knob 29 | adhesion release blade edge |
| | | 21 is in palm; thumb in |
| | | indentation; levered pressure |
| | | surface 22 is down and |
| | | forward (away from user) |
| Reverse | Levered Pressure Surface | Hand substantially wrapped |
| Enclosure | 22; Disc edge 23; Forearm | around midsection of tool; |
| Grip | arc blade edge 26 | thumb in indentation; |
| | | adhesion release blade edge |
| | | 21 is in palm; levered |
| | | pressure surface 22 rearward |
| | | (towards user); user can apply |
| | | leverage via application of |
| | | downward pressure from heel |
| | | of user's hand |

Note that certain components can be used by holding the tool via a grip that is different from that indicated above, although the specified grips should indeed provide the most comfortable and effective use of the indicated component. Further, certain components may be used via more than one grip (e.g., the lever disc 55); a user can select which grip to use for a certain component that can be used via a plurality of grips depending on the body part of the patient to be treated, orientation of the user relative to the patient or body part, force needed to treat as desired, personal preference, etc. And certain grips enable a user to change from the use of one component to another without changing grip (e.g., from adhesion release blade edge 21 to tendon release blade edge 25 for large palm grip).

Note also that even though the above table best describes the various grips of a nine component tool, it still enables design/manufacture/use of tools with fewer than nine components. In tools with fewer than such nine components, certain grip surfaces may still exist even though the tool components/parts that help to form such surfaces (as indicated above) may not even exist. For example, in a tool without a finger arc blade edge 27, a pressure knob 29 and/or a stripper 28, a large pistol grip can still be formed if a concave feature (functional or not) is established between two projections (functional or not). Accordingly, the above table (and the description herein of grips and grip surfaces generally) is not only descriptive, but also instructive in that one of ordinary skill in the relevant art could use such table/description to create, design, use or identify grip surfaces on a tool with fewer than nine therapeutic components.

Projections may project, radially, from a central tool portion; in certain embodiments, such may be a central tool body may make up much of the mass of the tool. While the term tool central body may indeed sound like a critical, required part of the tool, certain embodiments may exhibit a central tool portion that includes a hole (typically more than a pinhole) or thin width material in addition to structure that forms the border of that hole or thin width material. In some of such examples, there may still be a digit indentation 20 (i.e., the hole may be part of that indentation), and such central portion (i.e., including a hole in such examples) may still be functional, in that, e.g., it may enable a grip, at last in part (as where, e.g., a thumb on one side of the tool may meet, contact, and pinch against a finger on the other side of the tool). Note also that certain components may be said to be established at the end of projections (e.g., any disc edge 23, lever disc 55, tendon release blade edge 25, stripper 28 and/or pressure knob 29 that exists) that project, radially, from that central portion, whether it be entirely structure, or not (e.g., where it includes a hole).

As indicated, certain embodiments of the tool may provide one or more digit indentations (e.g., a comfort thumb/finger(s)s (digit) indentation), perhaps in the central region (portion) or body of the tool, perhaps on each side of the tool to improve grip allowing for application of greater force more precisely, provide a locational reference for the user (e.g., to facilitate fast repositioning from one grip to another), enhance user control, and/or provide a more ergonomic feel. Such indention may be referred to as a digit indentation. The digit indentation 20 may accept a thumb, a finger, fingers, a thumb and finger(s), digit knuckle, side of digit, etc., such that the user has in the digit indentation, e.g., a thumb alone, a thumb and finger, or one or more fingers (or even a portion of a palm, such as, e.g., the thumb muscle). As shown, certain grips (e.g., small palm grip) may involve the use of two digit indentations. Note that the digit indentation 20 may, but certainly need not, have some sort of surface treatment, e.g., knurling, cross-hatching, texturing, any pattern (including words in raised relief) cut, engraved, etched, molded or rolled into the surface, a thin surface layer or rubber, etc. Indeed any grip surface or portion thereof may, but need not, exhibit some sort of surface treatment. As such, grip surfaces may, but certainly need not, be of similar or identical character as non-grip surfaces.

Lotion or gel may be very helpful to help the tool glide over skin (or tight clothing should be worn, or use may occur in a shower). A stroke with a blade may last, e.g., a second or two (as but an example); it may be repeated as necessary (e.g., 5-20 times in both directions). Treatment may last 5-10 mins. on a region and may occur up to 3×/week, for example. Shorter treatment times at a lighter pressure may be best for acute conditions; longer treatment times with more pressure may be best for chronic conditions.

Certain embodiments of the inventive tool technology may feature or exhibit one or more of the following (in addition to or instead of features disclosed elsewhere in this application):
The tool may be symmetric about its bisecting plane 17 (it may split the tool into two mirror image identical halves), in certain embodiments. All therapeutic components of certain embodiments of the tool may be substantially in (and/or may be symmetric about) a bisecting plane.
All components of certain embodiments of the tool may be either substantially of a projection (e.g., substantially at the end of a projection that is substantially along a radius emanating from the tool's area centroid, i.e., a radial projection) or substantially between projections (e.g., on a concave feature (i.e., having a radius of curvature that extends away from the tool));
In certain embodiments, some components of the tool may, during typical component use, be moved (against a patient's skin) in a left-right direction defined by a vector that is normal to a bisecting plane 18, such as the rounded massage edge 24 or any of the blade edges (at the same time, the tool may be moved in a direction that is parallel to that direction defined by muscle), while other components, such as the stripper 28, during typical component use, may be moved in a forward-reverse direction (such vector typically lies within a bisecting plane); at the same time, the tool may be moved in a direction that is parallel to that direction defined by muscle.
Certain embodiments of the tool have more than one projections (each projecting radially from a tool central portion (which includes an area centroid of the tool), and perhaps substantially along radii lying within a bisecting plane); substantially at the end of each projection may be a therapeutic component, even different types of therapeutic component substantially at the ends (e.g., pressure knob 29, stripper 28, tendon release blade edge 25, and lever disc 55/disc edge 23). Each projection and each may be separated from two neighboring projections by a concave feature, each of which may also be a different therapeutic component (e.g., massage edge, finger arc blade edge 27, adhesion release blade edge 21, and forearm arc blade edge 26). Each of such different therapeutic components may have a different specialized function. Described another way, going clockwise (or counter clockwise), certain embodiments may feature a projecting therapeutic component, then a concave therapeutic component, then a different projecting therapeutic component, then different concave therapeutic component, etc. Note that in certain embodiments, such (therapeutic) components may be as positioned relative to each other in FIG. 1, but this is not required, as a tool having switched or rearranged positions of any of the therapeutic components (e.g., where the position of the stripper 28 and the tendon release blade edge 25) is within the ambit of the inventive technology. Embodiments of the tool may feature all therapeutic components such that their functional surfaces (e.g., blade or pressure surface) are established along the perimeter of a tool (when viewed from left or right of the tool). Note that FIG. 1 shows such a tool.
In certain embodiments, one or more of the projections (shape projecting radially from a tool center) may include two (or more) therapeutic components (for example, the lever disc 55 and disc edge 23 may both appear on the same projection).
In certain embodiments, there may, at one or more of projections of the tool, be an edgeless therapeutic component (e.g., levered pressure surface 22 and/or pressure knob 29). In certain embodiments, there may be one edgeless component as part of one projection (e.g., levered pressure surface, such as lever surface) and one as part of a different projection (e.g., pressure knob 29).
In certain embodiments, most or all rounder massage surfaces (e.g., massage edge, levered pressure surface 22 and/or pressure knob 29) may be established on an upper portion of the tool while most or all bladed components may be established on a lower portion of the tool.
The tool, in preferred embodiments, is three dimensional, unlike known steel edge tools that are flat and thin. Three dimensionality—including a non-negligible depth and thickness (in a left-right direction that is perpendicular (normal) to any bisecting plane) allows for superior ergonomics and comfort for the user, and may provide a volume, and heft and mass, that facilitates pressure application and administration of treatment.
In certain embodiments, the lever disc 55 component of certain tool designs is designed to sit in the palm of a user's hand when holding the tool with the large palm grip. The rounded and broad surface area of the lever disc 55 is comfortable in the hand and can allow for greater precision/control when using the tool.
In certain embodiments, the tool is unique in that it allows the user to apply greater pressures with the mechanical advantage of a lever arm 52 (note that because the axis of rotation observed in a user's rotational movement during use of certain components can change, the lever arm shown in FIG. 9 is but one of many lever arms that could be seen during leveraged use of the tool shown in that figure). In certain embodiments, leverage may be used to effect a leveraged pressure applied by the levered pressure surface 22; in one example of such levered use, the levered pressure surface (e.g., lever disc 55) may be placed against the muscle or tissue to be treated while the user holds the tool in the reverse enclosure grip position. In this position the user can use a length of the tool (or more particularly, the length of any projection at the end of which the lever disc 55 may be established) as a lever arm 52 and can achieve greater pressure to the tissue being treated. The reverse enclosure grip may also allow for use of the heel or part of the palm (e.g., proximal part) (enabling recruitment of strong forearm/hand muscles by the user) to apply pressure against one part of the tool in a rotational direction (e.g., clockwise for righthanded use), and the fingers to apply pressure in that same rotational direction, both in opposition to an opposing resistance from the contacted part of the patient's body in an opposite rotational direction. As suggested, such levered pressure may be facilitated or achieved via: establishment of certain components (e.g., lever disc 55 and/or disc edge 23) at the end of a projection (which may, but need not, have a longer radial length (from a tool area centroid) than other projections 53); and/or the provision of a reverse enclosure grip surface to allow for such grip during use of such components. Components that can be used in levered manner include but are not limited to the levered pressure surface 22 (e.g., lever disc 55); other components, even where not at the end of a longest projection of the tool, may also be used in levered manner, perhaps using a different grip (e.g., the pressure knob 29 via the enclosure grip).
In certain embodiments, the tool has unique digit indentation(s) that allows for easier gripping and greater precision.
In certain embodiments, shapes of therapeutic components in a single, one-piece tool are coordinated with each other and perhaps with central structure of the tool itself to provide comfortable, secure, intuitive, and/or ergonomic grip surfaces.
In certain embodiments, the tool is designed so a user can use multiple different components (e.g., edges/surfaces) without having to change grip position, and can change from one to another of such components without changing orientation. For example, the large palm grip allows the user to use the adhesion release blade edge 21, the tendon release blade edge 25, and the stripper 28 without changing grip positions.
In certain embodiments, the tool can accommodate users with different hand sizes due to its asymmetrical (in a plane that splits the tool in forward and rear “halves”) and/or front-to-back tapered shape. For example, users with large hands can hold the tool with the large palm grip and large pistol grip and users with smaller hands can hold using the small palm grip and small pistol grip (of course, options may be limited depending on which component is to be used). Other grips can accommodate either a small or large hand. Note that the tool can also accommodate right handed and left-handed users due to its symmetrical shape (about a plane that splits the tool into right and left halves) and its two thumb indentations (one on each right and left side), in certain embodiments.
Certain embodiments of the tool are unique in that in such embodiments, the tool has both blade edges to treat adhesion and scar tissue problems and rounded components (e.g., edges (that are not blade edges), disc and/or knob) to treat muscle tightness and trigger point problems within a muscle belly. Such components may be relatively established so as not to compromise ergonomic gripping of the tool.
Particular embodiments of the tool may exhibit therapeutic components established on a tool such that at least one of said components (including but not limited to a rounded massage edge 24, a finger arc blade edge 27, adhesion release blade edge 21, for example) is configured to treat a patient by moving (against skin of a patient) said component in a direction that is normal or angled to (but not along) the bisecting plane, and wherein at least one other of said components (including but not necessarily limited to a stripper 28, e.g.) is configured to treat a patient by moving the component in a forward/rearward direction 16, that is along that bisecting plane (i.e., parallel thereto, where parallel includes a direction that is within that plane). Note that regardless of whether the tool is being moved in a direction that is (a) within or (b) normal or angled to the bisecting plane, such movement may still be in direction that is parallel to muscle or tendon being treated (but need not necessarily be in such direction).
In certain embodiments, the tool has a unique feature—the finger arc blade—that is specific for treating finger pulley scarring/fibrosis or PIP and DIP collateral ligament scarring or fibrosis; particular embodiments may have an average radius of curvature of approx. 0.4″. The radius of curvature of the forearm arc blade edge 26, in particular embodiments, may be approx. 1″. Such radii are merely exemplary.
In certain embodiments, there may be a tendon release blade edge and a disc edge that present substantially at the end of a projection of the tool, as convexly curved edges; certain other edges (e.g., the forearm arc blade edge, the finger arc blade edge, the adhesion release blade edge and/or the massage edge) typically present as concavely curved edges, and at locations other than projections. Embodiments of the inventive tool may comprise one, two, three or four concavely curved edges; one or two edges substantially at the end of a projection; and/or one or two edges that are convexly curved.

The tool may be made via many different manufacturing techniques, including, by way of example only, any known manufacturing methods, including but not limited to: injection molding, 3D printing, molding generally, material removal, etc. The tool may, but need not, be solid material(s) throughout (solid body); hollow body designs may, but need not, be filled with material (fluid, gel, sand, etc.). Whether solid body or not (e.g., shell construction), a large variety of materials may be used, including but not limited to resin, plastic, nylon, polymer, any of which may be reinforced (e.g., with fiberglass (e.g., 5% by volume, or mass, 10%, or other amounts), aluminum, metal, wood, steel, titanium, alloy, different materials, layers of materials, etc. (as but a few examples) As suggested, it may even have a first material used to form the outer surface of the tool (i.e., a shell), forming an internal cavity that may or may not be filled with additional material (e.g., sand, fluid, gel, etc.). Typically, whatever construction is used, the tool will be sufficiently rigid to apply pressure as desired.

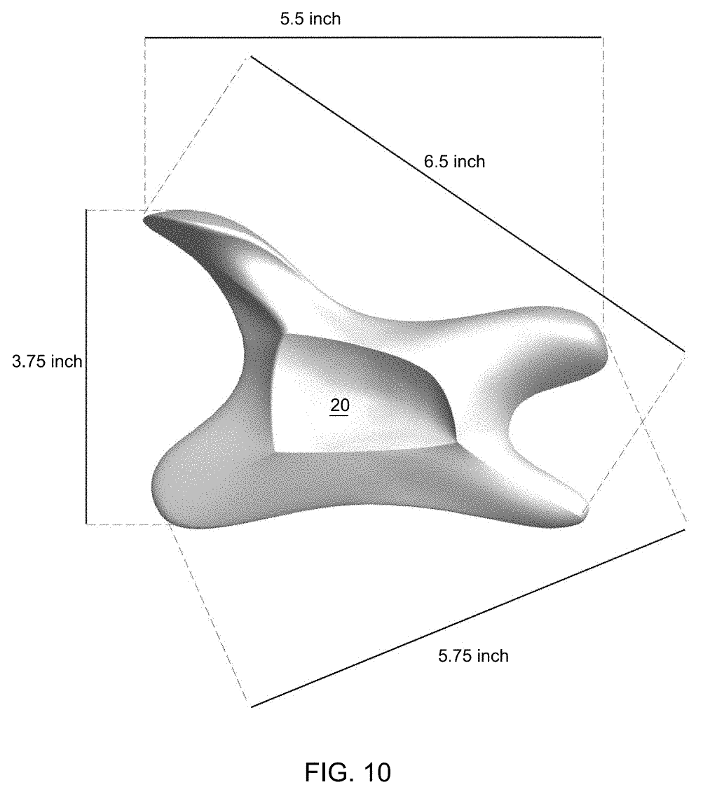

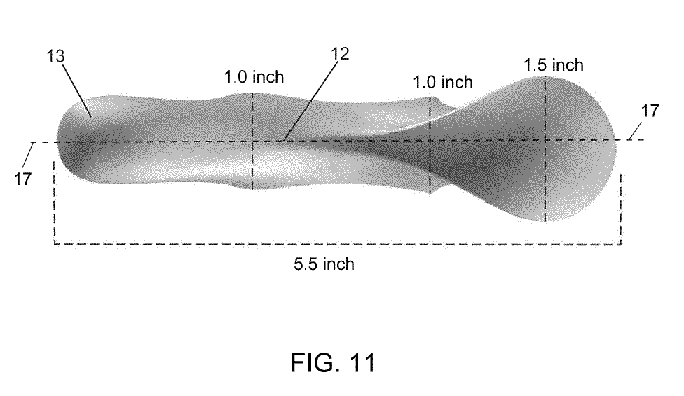

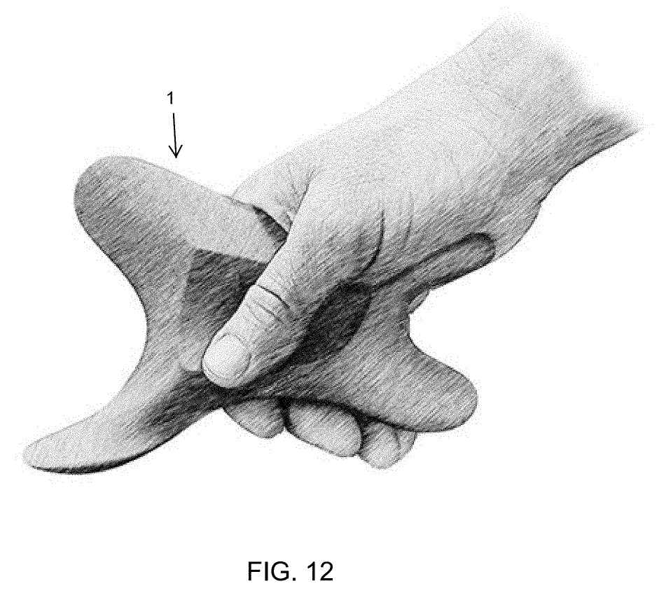

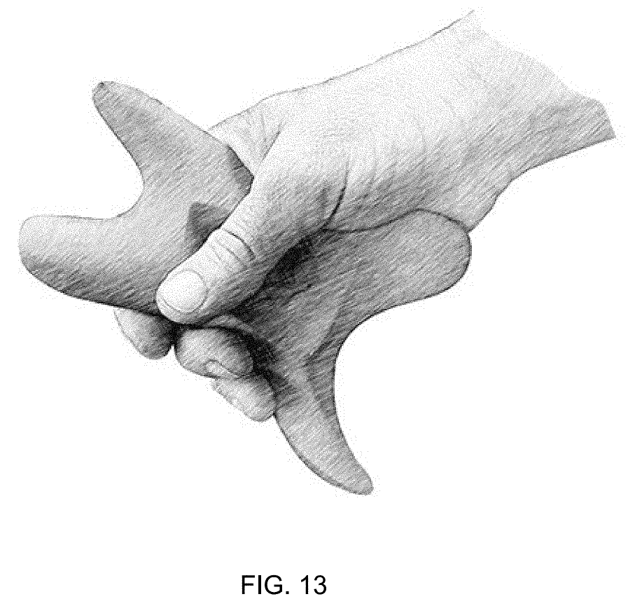

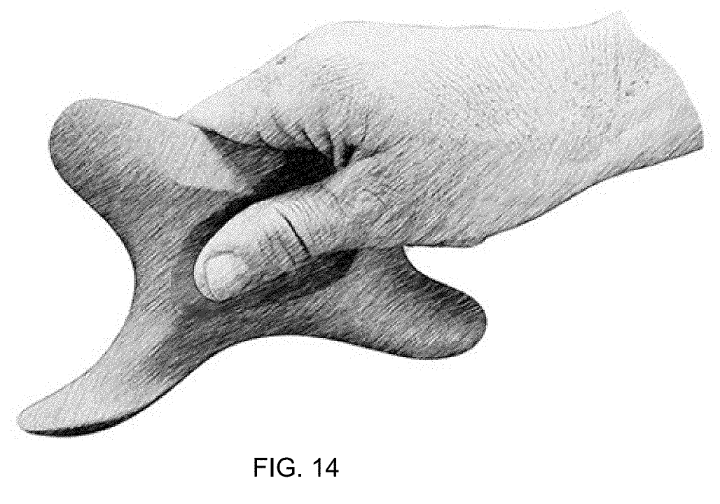

An embodiment of the tool may exhibit a variety of dimensions (and ratios therebetween), including but not limited to those given in FIGS. 10 and 11. Note that any other dimensions of this exemplary tool (including radii of curvature) can be discerned from that figure, given its scale and the dimensions shown. It is also of note that the ratios of dimensions of the tool shown in FIGS. 10 and 11 are also exemplary, and that the tool is not limited to the dimensions shown and any of the dimensional ratios shown. However, a 20% window centered on ratios shown (e.g., between the front to back length of 5.5″ and the front portion maximum thickness of 1″) may be preferred (although not required). Note that significantly larger versions are within the ambit of the inventive technology; such may find application on, e.g., horses. Such versions may have radii of curvature (e.g., of the forearm arc blade edge 26) adjusted to substantially mimic radii of curvature of certain horse parts (e.g., of a horse leg). Similarly, adolescents, or small mammals, e.g., may benefit from smaller versions. Note that, in certain embodiments, a preferred range for the length of the tendon release blade edge 25 may be ¾″ to 1½, while a preferred range for the length of the adhesion release blade edge 21 is 4½-8″.

The inventive technology may include inventive methods (e.g., of manufacture and/or of use). Descriptions of some of such methods may “track” the apparatus (tool) descriptions. Accordingly, inventive methods may include but not be limited to: using the tool, including any one of its components, and then using a different component of the same tool, with or without switching grip; using a tool that is as disclosed anywhere in this specification; using a levered component of a tissue manipulation tool 1 (e.g., physical therapy tool); gripping a tissue manipulation tool 1 in such a manner as to apply a force or pressure to a patient with leverage; using a stripper 28 as that stripper 28 is disclosed herein; using a finger arc blade edge 27 as that edge is disclosed herein; using a lever disc 55 to achieve any effect indicated herein; and using a disc edge 23 of a tool so as to apply a force under bone or tissue to achieve therapeutic effect. Inventive methods of manufacturing a tool to have any of the features or characteristics (e.g., dimensions, or components) disclosed herein are also a part of the inventive technology.

The tool, in embodiments, is not limited to sale to professionals (e.g., therapists such as physical therapist or massage therapist, or other health care professionals) only. Indeed, it may also be sold to the general public so that an individual, non-professional purchaser can use it on him or herself (self-administration), or another individual. Any sales, and particularly those to the general public, may include instructional materials explaining how to use the tool (see Appendix 1, incorporated herein) or an indication of instructional internet-based resources. Particular embodiments of the tool may be referred to as the Wave Tool™.

As can be easily understood from the foregoing, the basic concepts of the present invention may be embodied in a variety of ways. It involves both tissue manipulation techniques as well as devices to accomplish the appropriate manipulation. In this application, the tissue manipulation techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “pressure surface” should be understood to encompass disclosure of the act of “applying pressure with that surface”—whether explicitly discussed or not—and, conversely, were there effectively disclosure of the act of “applying pressure”, such a disclosure should be understood to encompass disclosure of a surface that can apply pressure” and even a “means for applying pressure” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the tissue manipulation devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An ergonomic, handheld tissue manipulation tool, comprising:
a central tool portion;
at least one blade edge therapeutic component established radially outward from said central tool portion; and
at least one rounded therapeutic component established radially outward from said central tool portion.

2. An ergonomic, handheld tissue manipulation tool as described in claim 1 further comprising at least one grip surface to facilitate use of said at least one blade edge therapeutic component, said at least one grip surface selected from the group consisting of pistol grip surface, pinch grip surface, enclosure grip surface, and palm grip surface.

3. An ergonomic, handheld tissue manipulation tool as described in claim 1 further comprising at least one grip surface to facilitate use of said at least one rounded therapeutic component, said at least one grip surface selected from the group consisting of pistol grip surface, pinch grip surface, and enclosure grip surface.

4. An ergonomic, handheld tissue manipulation tool as described in claim 1 further comprising at least two grip surfaces selected from the group consisting of: large pistol grip surface, small pistol grip surface, large palm grip surface, small palm grip surface, pinch grip surface, enclosure grip surface and reverse enclosure surface.

5. An ergonomic, handheld tissue manipulation tool as described in claim 1 further comprising a reverse enclosure grip surface.

6. An ergonomic, handheld tissue manipulation tool as described in claim 1 further comprising at least one ergonomic grip surface.

7. An ergonomic, handheld tissue manipulation tool as described in claim 1 wherein said at least one blade edge therapeutic component comprises a component selected from the group consisting of: arced blade edge component, a disc edge component, a tendon release blade edge component and an adhesion release blade edge component.

8. An ergonomic, handheld tissue manipulation tool as described in claim 1 wherein said at least one rounded therapeutic component comprises a component selected from the group consisting of massage edge component, pressure knob component and levered pressure surface component.

9. An ergonomic, handheld tissue manipulation tool as described in claim 1 wherein said at least one rounded therapeutic component comprises a rounded, edgeless surface component.

10. An ergonomic, handheld tissue manipulation tool as described in claim 1 further comprising a digit indentation.

11. An ergonomic, handheld tissue manipulation tool as described in claim 1 further comprising at least one radial projection.

12. An ergonomic, handheld tissue manipulation tool as described in claim 11 wherein each of said at least one rounded component is established at the end of a different one of said at least one radial projection.

13. An ergonomic, handheld tissue manipulation tool as described in claim 12 wherein said at least one radial projection comprises two radial projections.

14. An ergonomic, handheld tissue manipulation tool as described in claim 13 wherein said at least one rounded therapeutic component comprises two rounded therapeutic components, each of which is established at the end of a different one of said two radial projections.

15. An ergonomic, handheld tissue manipulation tool as described in claim 1 wherein all said therapeutic components are established along a perimeter of said tool.

16. An ergonomic, handheld tissue manipulation tool having a shape that defines a tool perimeter, said tool comprising:
at least one edge therapeutic component established along said tool perimeter; and
at least one edgeless therapeutic component established along said tool perimeter.

17. An ergonomic, handheld tissue manipulation tool as described in claim 16 further comprising at least one grip surface to facilitate use of said at least one edge therapeutic component, said at least one grip surface selected from the group consisting of pistol grip surface, pinch grip surface, palm grip surface and enclosure grip surface.

18. An ergonomic, handheld tissue manipulation tool as described in claim 16 further comprising at least one grip surface to facilitate use of said at least one edgeless therapeutic component, said at least one grip surface selected from the group consisting of pistol grip surface and enclosure grip surface.

19. An ergonomic, handheld tissue manipulation tool as described in claim 16 further comprising at least two grip surfaces to facilitate use of components of said tool, said at least two grip surfaces selected from the group consisting of: large pistol grip surface, small pistol grip surface, large palm grip surface, small palm grip surface, pinch grip surface, enclosure grip surface and reverse enclosure surface.

20. An ergonomic, handheld tissue manipulation tool as described in claim 16 further comprising a reverse enclosure grip surface.

21-166. (canceled)
